(19) United States
(12) Patent Application Publication
(10) Pub. No.: US 2026/0010106 A1
(43) Pub. Date: Jan. 8, 2026

(54) IMAGE FORMING APPARATUS

(71) Applicant: CANON KABUSHIKI KAISHA, Tokyo (JP)

(72) Inventors: HARUHIKO OMATA, Chiba (JP); HIDEO NAGURA, Saitama (JP)

(21) Appl. No.: 19/261,382

(22) Filed: Jul. 7, 2025

(30) Foreign Application Priority Data
Jul. 8, 2024 (JP) 2024-109926

(51) Int. Cl. G03G 15/00; G03G 15/01; G03G 15/16; G03G 21/12

(52) U.S. Cl. CPC G03G 15/553; G03G 15/0131; G03G 15/0189; G03G 15/161; G03G 15/5016; G03G 21/12

(57) ABSTRACT

An image forming apparatus includes an image forming portion for forming a toner image on an image bearing member; a belt unit including an endless belt onto which the toner image is transferred from the image bearing member and a collected toner container provided in a region constituted by an inner peripheral surface of the belt and for accommodating toner collected in the main assembly; a first acquiring portion for acquiring a value relating to a remaining lifetime of the belt; a second acquiring portion for acquiring a value relating to a remaining lifetime of the collected toner container; and a processing portion for executing processing for notifying information on a remaining lifetime of the belt unit on the basis of a first acquisition result by the first acquiring portion and a second acquisition result by the second acquiring portion.

### BACKGROUND

### Field of the Technology

The present disclosure relates to an image forming apparatus, such as a copying machine, a printer, a facsimile machine, or a multi-function machine having a plurality of functions of functions of these machine, using an electrophotographic type or an electrostatic recording type.

### Description of the Related Art

Conventionally, as the image forming apparatus using the electrophotographic type, there is an image forming apparatus provided with an endless belt, stretched by a plurality of stretching rollers, such as an intermediary transfer belt or a conveying belt. For example, the image forming apparatus provided with the intermediary transfer belt forms an image on a recording material by primary transferring a toner image, formed on an image bearing member, onto the intermediary transfer belt and then by secondarily the toner image onto the recording material such as paper. Further, the image forming apparatus provided with the conveying belt forms an image on the recording material by transferring the toner image, formed on the image bearing member, onto the recording material carried and conveyed by the conveying belt. In the following, the image forming apparatus provided with the intermediary transfer belt will be principally described as an example.

On the intermediary transfer belt after the toner image is transferred, toner (transfer residual toner) not transferred onto the recording material remains. The image forming apparatus is provided with a cleaning device for cleaning the intermediary transfer belt by removing this transfer residual toner from on the intermediary transfer belt. The residual toner removed from on the intermediary transfer belt by the cleaning device is collected in a collected toner container, for accommodating the toner, provided in the image forming apparatus. Herein, the toner removed and collected from the intermediary transfer belt is also referred to as “collected toner”.

The intermediary transfer belt is a consumable (part). The image forming apparatus is constituted so as to be exchangeable in the form of a belt unit (intermediary transfer belt unit) provided with the intermediary transfer belt and stretching rollers or the like therefor in some instances. Further, the collected toner container is also the consumable part. The image forming apparatus is constituted so that the collected toner container is exchanged in the case where the collected toner container became full with the count. The collected toner container is installed in a position where a user easily takes out the collected toner container so that the unit of the image forming apparatus is capable of exchanging the collected toner container.

Further, the image forming apparatus employs, in some instances, a constitution in which information on a remaining lifetime of the consumable part is capable of being displayed on an information confirmation screen or the like in order to know that how long a remaining lifetime of the consumable part remains for discrimination of exchange/non-exchange of the consumable part, preparation of the consumable part for exchange, and the like. In an image forming apparatus having a general constitution in which the belt unit and the collected toner container are separately provided, remaining lifetimes thereof can be confirmed so that the remaining lifetime of the belt unit is what % and the remaining lifetime of the collected toner container is what %. Further, in some instances, in the case where each of the belt unit and the collected toner container reached an end of a lifetime thereof, the image forming apparatus has a constitution in which information showing that each of the belt unit and the collected toner container reached the end of the lifetime thereof or information prompting exchange of each of the belt unit and the collected toner container is displayed on the information confirmation screen or the like.

On the other hand, in Japanese Laid-Open Patent Application No. 2020-197702, an image forming apparatus in which the collected toner container is installed in a space inside the belt unit is disclosed. By employing such a constitution, a space for the collected toner container provided outside the belt unit is not needed, and therefore, there is an advantage such that downsizing of an apparatus main assembly of the image forming apparatus can be realized. In addition, exchange of the intermediary transfer belt and exchange of the collected toner container can be made at the same time by exchanging the belt unit, and therefore, there is an advantage such that an exchange frequency of the consumable part can be reduced.

However, in the constitution in which the collected toner container is included in the belt unit, the collected toner container cannot be recognized even when the user sees an outer appearance of the belt unit. For that reason, even when the remaining lifetime of the collected toner container is displayed on the information confirmation screen or the like, there is a possibility that the user cannot know that the remaining lifetime of what part is displayed and is confused.

Incidentally, the same can also be said for a constitution in which the collected toner container is provided inside a belt unit (conveying belt unit) provided with the conveying belt and stretching rollers therefor.

### SUMMARY OF THE INVENTION

The present disclosure is directed to provide an image forming apparatus capable of improving usability of a user relating to exchange of a belt unit in a constitution in which a collected toner container is provided inside the belt unit.

This has been achieved by an image forming apparatus according to the present disclosure.

According to an aspect of the present disclosure, there is provided an image forming apparatus comprising: an image forming portion configured to form a toner image on an image bearing member; a belt unit detachably mountable to a main assembly of the image forming apparatus and including an endless belt onto which the toner image is transferred from the image bearing member and a collected toner container which is provided in a region constituted by an inner peripheral surface of the belt and which is configured to accommodate toner collected in the main assembly; a first acquiring portion configured to acquire a value relating to a remaining lifetime of the belt; a second acquiring portion configured to acquire a value relating to a remaining lifetime of the collected toner container; and a processing portion configured to execute processing for notifying information on a remaining lifetime of the belt unit on the basis of a first acquisition result by the first acquiring portion and a second acquisition result by the second acquiring portion.

According to another aspect of the present disclosure, there is provided an image forming apparatus comprising: an image forming portion configured to form a toner image on an image bearing member; a belt unit detachably mountable to a main assembly of the image forming apparatus and including an endless belt for carrying and conveying a recording material onto which the toner image is transferred from the image bearing member and a collected toner container which is provided in a region constituted by an inner peripheral surface of the belt and which is configured to accommodate toner collected in the main assembly; a first acquiring portion configured to acquire a value relating to a remaining lifetime of the belt; a second acquiring portion configured to acquire a value relating to a remaining lifetime of the collected toner container; and a processing portion configured to execute processing for notifying information on a remaining lifetime of the belt unit on the basis of a first acquisition result by the first acquiring portion and a second acquisition result by the second acquiring portion.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic perspective view showing an outer appearance of an image forming apparatus according to an embodiment.

FIG. 2 is a schematic sectional view showing a schematic structure of an inside of the image forming apparatus.

FIG. 3 is a schematic sectional view showing a schematic structure of an image forming portion.

FIG. 4 is a schematic perspective view of a belt unit.

FIG. 5 is a schematic perspective view showing a drive transmitting portion of the belt unit.

FIG. 6 is a schematic sectional view of the belt unit.

FIG. 7 is a schematic side view of the belt unit.

FIG. 8 is a schematic top (plan) view of the belt unit.

Parts (a) and (b) of FIG. 9 are block diagrams each showing a control constitution of the image forming apparatus.

FIG. 10 is a flowchart showing an example of a procedure of remaining lifetime display of the belt unit.

FIG. 11 is a schematic view of an example of the remaining lifetime display of the belt unit.

FIG. 12 is a graph showing an example of progression of remaining lifetimes of an intermediary transfer belt and a collected toner container.

FIG. 13 is a flowchart showing an example of a procedure of an operation after the belt unit reaches an end of a lifetime thereof.

Parts (a), (b), and (c) of FIG. 14 are schematic views showing examples of a setting screen, an alert screen, and another alert screen, respectively.

FIG. 15 is a schematic view showing an example of another setting screen.

FIG. 16 is a flowchart showing another example of the procedure of remaining lifetime display of the belt unit.

FIG. 17 is a schematic sectional view showing a schematic structure of an image forming apparatus according to another embodiment.

### DESCRIPTION OF THE EMBODIMENTS

In the following, with reference to the drawing, embodiments of the present disclosure will be described as an example. However, dimensions, materials, shapes, a relative arrangement, and the like of constituent parts described in the following embodiments can be appropriately changed depending on constitutions and various conditions of apparatuses to which the present disclosure is applied.

That is, the present disclosure is not limited to the following embodiments.

### Embodiment 1

### 1. Structure of Image Forming Apparatus

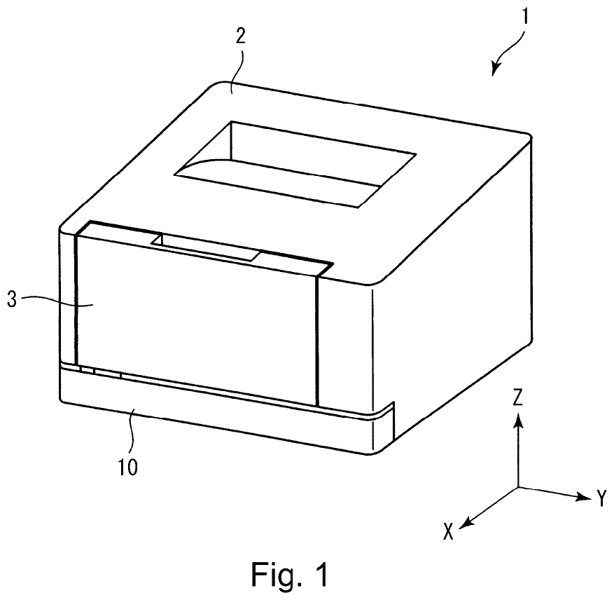

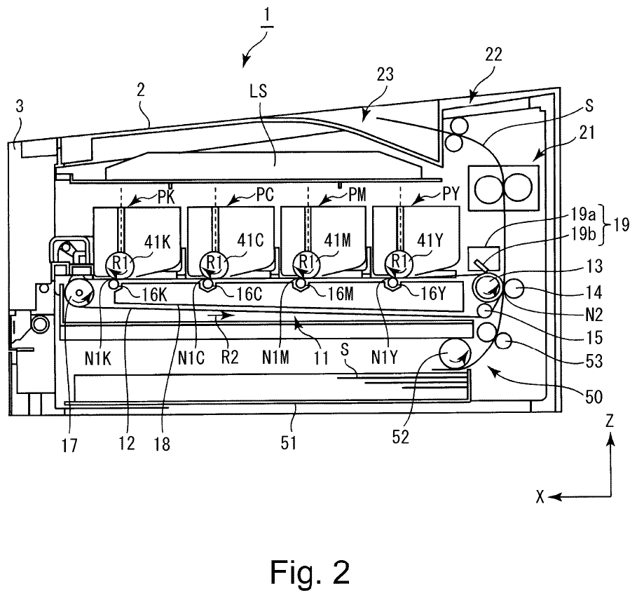

FIG. 1 is a schematic perspective view showing an outer appearance of an image forming apparatus 1 according to an embodiment 1. FIG. 2 is a schematic sectional view showing a schematic structure of an inside of the image forming apparatus 1 of this embodiment. The image forming apparatus 1 of this embodiment is a tandem-type laser printer capable of forming a full-color image by using an electrophotographic type and employing an intermediary transfer type.

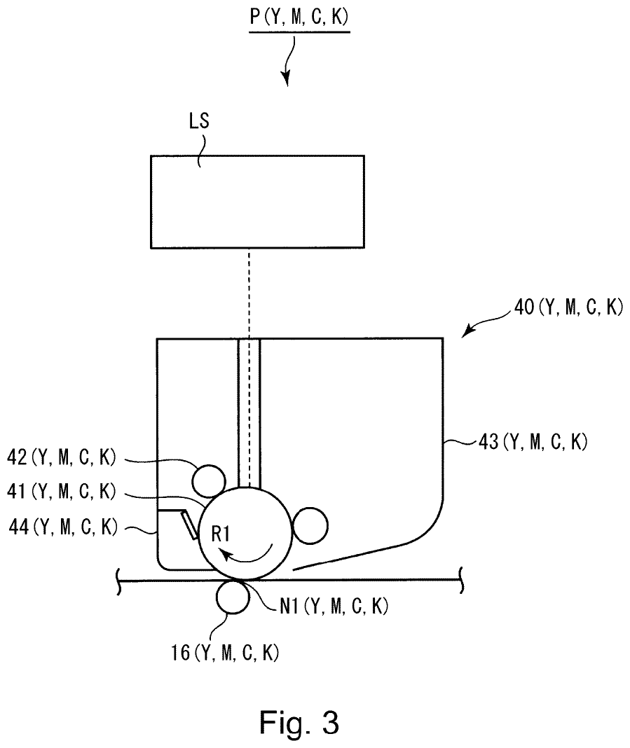

The image forming apparatus 1 includes four image forming portions PY, PM, PC, and PK for forming images of four colors of yellow (Y), magenta (M), cyan (C), and black (K), respectively. As regards elements having the same or corresponding functions or constitutions provided for the respective colors, suffixes Y, M, C, and K of numerals or symbols each showing the element for an associated one of the colors are omitted and the elements will be collectively described in some instances. FIG. 3 is a schematic sectional view showing a schematic structure of a single image forming portion P. In this embodiment, the image forming portion is constituted by including a photosensitive drum 41 (41Y, 41M, 41C, 41K), a charging roller 42 (42Y, 42M, 42C, 42K), an exposure provided LS, a developing device 43 (43Y, 43M, 43C, 43K), a drum cleaning device 44 (44Y, 44M, 44C, 44K), and the like. In this embodiment, the exposure device LS is constituted as a single unit for exposing the photosensitive drums 41Y, 41M, 41C, and 41K to light, but may also be independently provided for each of the photosensitive drums 41Y, 41M, 41C, and 41K.

Further, in this embodiment, the image forming apparatus 1 employs a process cartridge type.

In each image forming portion P, the photosensitive drum 41, and as process means actable thereon, the charging roller 42, the developing device 43, and the drum cleaning device 44 integrally constitute a process cartridge 40 detachably mountable to an apparatus main assembly 2 of the image forming apparatus 1. Four process cartridges 40Y, 40M, 40C, and 40K are provided and arranged in line with certain intervals. Demounting or mounting of each process cartridge 40 and a belt unit 11 described later relative to the apparatus main assembly 2 is performed in a state in which an openable (/closable) door 3 provided to the image forming apparatus 1 is open. In this embodiment, the apparatus main assembly 2 of the image forming apparatus 1 corresponds to a portion excluding the process cartridges 40 and the belt unit 111 from the image forming apparatus 1.

Further, as regards the image forming apparatus 1, a side (left side in FIG. 2) where the openable door 3 is provided is a “front (front surface) side”, and an opposite side (right side in FIG. 2) from the front side is a “rear (rear surface) side”. Further, when the image forming apparatus 1 is viewed from the front side, a right side is a “driving side” and a left side is a “non-driving surface”.

The image forming apparatus 1 is used by being disposed so that each of a direction connecting the front side and the rear side and a direction connecting the driving side and the non-driving side is substantially horizontal. Further, in

FIG. 2, a direction from the rear side toward the front side is a “(+) X direction”. Further, a direction (perpendicular to the X direction) from the non-driving side toward the driving side is a “(+) Y direction”. further, a direction (perpendicular to the X direction and the Y direction) from a bottom toward a top surface in the case where the image forming apparatus 1 is disposed on a horizontal surface is a “(+) Z direction”. Here, as regards the image forming apparatus 1, an “up” and “down” direction refers to “up” and “down” in a direction of gravitation (vertical direction), but does not mean only “Just above” and “just below”, and includes “upper side” and “lower side” than a horizontal plane passing through a noting position or a noting element. Further, in a state in which the image forming apparatus 1 is capable of forming an image, rotational axis directions of the photosensitive drums 41 and stretching rollers for an intermediary transfer belt 12, which are described later are substantially parallel to the Y direction.

The process cartridges 40 are arranged and disposed substantially horizontal to the bottom of the apparatus main assembly 2. Each process cartridge 40 includes an electrophotographic process mechanism including the photosensitive drum 41, the charging roller 42, the developing device 43, the drum cleaning device 44, and the like, and to which a rotational driving force is transmitted from a driving source (not shown) provided in the apparatus main assembly 2. further, above the process cartridge 40, the exposure device LS is provided. The exposure device LS outputs laser light on the basis of image information received from an external device such as a personal computer by a video controller 60 (part (a) of FIG. 9). The laser light outputted from the exposure device LS passes through an exposure window portion of the process cartridge and with which ha surface (outer peripheral surface) of the photosensitive drum 41 is scanned and exposed.

Further, under the process cartridge 40, the belt unit (intermediary transfer belt unit) 11 is provided. The belt unit 11 is constituted by including the intermediary transfer belt 12, primary transfer rollers 16Y, 16M, 16C, and 16K, a driving roller 13, a tension roller 17, a pre-secondary transfer roller 15, a belt cleaning device 19, a collected toner container 18, and the like. The belt unit 11 is constituted so as to be detachably mountable to the apparatus main assembly.

The intermediary transfer belt 12 constituted by a rotatable endless belt as an intermediary transfer member is extended around, as a plurality of stretching rollers, the driving roller 13, the tension roller 17, and the pre-secondary transfer roller 15, and is stretched by these rollers under predetermined tension. Incidentally, herein, the intermediary transfer belt is also referred to as an “ITB (Intermediary (Intermediate) Transfer Belt)”. The driving roller 13 is rotated by receiving a driving force from a driving device (not shown) provided in the apparatus main assembly 2. By this, the intermediary transfer belt 12 is rotated (circulated and moved) in an arrow R2 direction (counterclockwise direction) in FIG. 2. The tension roller imparts the predetermined tension to the intermediary transfer belt 12. By the driving roller 13 and the tension roller 17, a surface (primary transfer surface) of the intermediary transfer belt 12 passing through each of primary transfer portions N1 described later. The pre-secondary transfer roller 15 forms a surface (secondary transfer surface) of the intermediary transfer belt 12 entering a secondary transfer portion N2 described later. The belt cleaning device 19 removes and collects transfer residual toner from on the intermediary transfer belt 12. The toner collected from on the intermediary transfer belt 12 by the belt cleaning device 19 is accommodated in the collected toner container 18 provided in a region constituted by an inner peripheral surface of the intermediary transfer belt 12.

The primary transfer roller 16 which is a roller-type primary transfer member is an example of a primary transfer means for transferring a toner image, carried on the photosensitive drum 41, from the photosensitive drum 41 onto the intermediary transfer belt 12. The primary transfer roller 16 is disposed in contact with the inner peripheral surface of the intermediary transfer belt 12. The respective primary transfer rollers 16Y, 16M, 16C, and 16K are provided correspondingly to the photosensitive drums 41Y, 41M, 41C, and 41K, respectively, through the intermediary transfer belt 12. Each of the primary transfer rollers 16 is provided and extended along a direction substantially perpendicular to a surface movement direction of the intermediary transfer belt 12, i.e., along the Y direction. The primary transfer roller 16 urges the intermediary transfer belt toward the associated photosensitive drum 41, and forms a primary transfer portion (primary transfer nip) N1 (N1Y, NIM, NIC, N1K) where the photosensitive drum 41 and the intermediary transfer belt 12 are in contact with each other.

In this embodiment, the primary transfer roller 16 is constituted by a metal roller including no elastic layer. In this embodiment, the primary transfer roller 16 is disposed so as to be deviated from a position of the primary transfer portion N1 where the photosensitive drum 41 and the intermediary transfer belt 12 are in contact with each other. Specifically, in this embodiment, the primary transfer roller 16 is disposed so as to be shifted toward a side downstream of the position of the primary transfer portion N1 with respect to a surface movement direction of the intermediary transfer belt 12. By this, a possibility that the primary transfer roller 16 constituted by the metal roller abrades the photosensitive drum 41 is reduced. The primary transfer roller 16 may also be disposed so as to be shifted toward a side upstream of the position of the primary transfer portion N1.

The belt cleaning device 19 includes a cleaning container (cleaning frame) 19a and a cleaning blade 19b provided inside the cleaning container 19a and as a cleaning member (collecting member) extending along the Y direction. The cleaning blade 19b is disposed in contact with a surface (outer peripheral surface) of the intermediary transfer belt 12 so as to extend in a direction counter to the surface movement direction of the intermediary transfer belt 12. The cleaning blade 19b scrapes off the transfer residual toner from the surface of the rotating intermediary transfer belt 12 and then collects the transfer residual toner in the cleaning container 19a.

The driving roller 13 which is a rotatable driving member has a function of a secondary transfer opposite roller. On an outer peripheral surface side of the intermediary transfer belt 12, in a position opposing the driving roller 13 through the intermediary transfer belt 12, a secondary transfer roller 14 which is a roller-type secondary transfer member as a secondary transfer means is provided. The secondary transfer roller 14 is pressed toward the driving roller 13 and is contacted to the driving roller 13 through the intermediary transfer belt 12, and forms a secondary transfer portion (secondary transfer nip) N2 where the secondary transfer roller 14 and the intermediary transfer belt 12 are in contact with each other.

With respect to the conveying direction, on the side upstream of the secondary transfer portion N2, a feeding device 50 as a feeding means for feeding the recording material S toward the secondary transfer portion N2 is provided. The feeding device 50 is constituted by including a cassette 51 as a recording material accommodating portion, a feeding roller 52 as a feeding member, registration roller pair 53 as a conveying member, and the like. The cassette 51 accommodates the recording material S. The feeding roller 52 feeds the recording material S from the cassette 51. The registration roller pair 53 conveys the recording material S, toward the secondary transfer portion N2, fed from the cassette 51 by the feeding roller 52.

Further, with respect to the conveying direction of the recording material S, on the side downstream of the secondary transfer portion N2, a fixing device 21 as a fixing means for fixing the toner image on the recording material S and a discharging roller pair 22 for discharging the recording material S, from the apparatus main assembly 2, on which the toner image is fixed. The recording material S discharged from the apparatus main assembly 2 by the discharging roller pair 22 is stacked on the tray 23 as a discharge portion (stacking portion) provided at an upper portion of the tray 23.

### 2. Image Forming Operation

Next, an image forming operation of the image forming apparatus 1 of this embodiment will be described.

A video controller 60 (part (a) of FIG. 9) receives image information (image signal) from an external device, whereby the image forming operation is started by a controller 30 (part (a) of FIG. 9). When the image forming operation is started, the photosensitive drum 41, the driving roller 13, and the like start rotation at a predetermined peripheral speed (process) speed by a driving force from a driving source of a driving device (not shown).

A surface of the photosensitive drum 41 is electrically charged uniformly to a predetermined polarity (negative polarity in this embodiment) and a predetermined potential by the charging roller 42 which is a roller-type charging member as a charging means. The charged surface of the photosensitive drum 41 is irradiated with laser light depending on the image information by the exposure device (laser scanner) LS as an exposure means and thus is subjected to scanning exposure, so that an electrostatic latent image (electrostatic image) depending on the image information is formed on the photosensitive drum 41. The electrostatic latent image formed on the photosensitive drum 41 is developed (visualized) by being supplied with toner as a developer by the developing device 43 as a developing means, so that a toner image (toner picture, developer image) depending on the image information is formed on the photosensitive drum 41. On the photosensitive drums 41Y, 41M, 41C, and 41K, toner images depending on image components of the colors of yellow, magenta, cyan, and black, respectively, are formed. In this embodiment, on an exposed portion on each photosensitive drum 41 lowered in absolute value of the potential by being exposed to the laser light after being charged uniformly, toner charged to the same polarity as a charge polarity (negative polarity in this embodiment) of the photosensitive drum 41 is deposited (reverse development type). In this embodiment, a normal charge polarity of the toner, which is a principal charge polarity of the toner during the development is the negative polarity.

The toner image formed on the photosensitive drum 41 reaches the primary transfer portion N1 with rotational of the photosensitive drum 41. Then, this toner image is transferred (primary transferred) onto the rotating intermediary transfer belt 12 by the action of the primary transfer roller 16 in the primary transfer portion N1. During the primary transfer, to the primary transfer roller 16, by a primary transfer power source (not shown), a primary transfer voltage (primary transfer bias) which is a DC voltage of an opposite polarity (positive polarity in this embodiment) to the normal charge polarity of the toner is applied. For example, during full-color image formation, the color toner images of yellow, magenta, cyan, and black are successively primary-transferred superposedly onto the intermediary transfer belt 12 in the primary transfer portions N1. By this, on the intermediary transfer belt 12, the four color toner images corresponding to an objective color image are formed.

The toner images formed on the intermediary transfer belt 12 reach the secondary transfer portion N2 with movement of the intermediary transfer belt 12. Then, the toner images are transferred (secondarily transferred) onto a sheet-like recording material S nipped and conveyed between the intermediary transfer belt 12 and the secondary transfer roller 14 by the action of the secondary transfer roller 14 in the secondary transfer portion N2. During the secondary transfer, to the secondary transfer roller 14, by a secondary transfer power source (not shown), a secondary transfer voltage (secondary transfer bias) which is a DV voltage of the opposite polarity to the normal charge polarity of the toner is applied. The driving roller 13 is electrically grounded (connected to the grounded). Incidentally, a constitution in which a secondary transfer voltage of the same polarity as the normal charge polarity of the toner is applied to an inner roller corresponding to the driving roller 13 and in which an outer roller corresponding to the secondary transfer roller 14 in this embodiment is electrically grounded may be employed.

The recording materials S (transfer materials, recording media, sheets) S such as paper and plastic sheet (for example, OHP sheet) are accommodated in the cassette 51. The recording materials S accommodated in the cassette 51 are fed one by one from the cassette 51 by the feeding roller 52 or the like at a predetermined timing, and then is conveyed toward the secondary transfer portion N2 by being timed to the toner image on the intermediary transfer belt 12 by the registration roller pair 53.

The recording material S on which the toner image is transferred in the secondary transfer portion N2 is conveyed toward the fixing device 21. The fixing device 21 heats and presses the recording material S on which the unfixed toner image is carried, and fixes (melts, sticks) the toner image on the recording material S. The recording material S on which the toner image is fixed is discharged (outputted) from the apparatus main assembly 2 by the discharging roller pair 22 or the like, and is stacked on a tray 23.

On the other hand, the transfer residual toner (primary transfer residual toner) remaining on the photosensitive drum 41 after the primary transfer is removed and collected from on the photosensitive drum 41 by the drum cleaning device 44 as a photosensitive member cleaning means. Further, the transfer residual toner (secondary transfer residual toner) remaining on the intermediary transfer belt 12 after the secondary transfer is removed and collected from on the intermediary transfer belt 12 by the belt cleaning device 19 as a belt cleaning means.

By the above-described operation, for example, a full-color print image is formed.

### 3. Belt Cleaning Device

Next, cleaning of the intermediary transfer belt 12 by the belt cleaning device 19 in this embodiment will be further described.

The transfer residual toner remaining on the intermediary transfer belt 12 after the secondary transfer is scraped off from on the intermediary transfer belt 12 by the cleaning blade 19b and is temporarily accommodated in the cleaning container 19a. In the following, a collecting step of the transfer residual toner by the belt cleaning device 19 will be described. Incidentally, in addition to the transfer residual toner, the belt cleaning device 19 is capable of removing and collecting a deposited matter on the intermediary transfer belt 12 from on the intermediary transfer belt 12. As this deposited matter, it is possible to cite toner of a test toner image formed on the intermediary transfer belt 12 for the purposes of image density control, color deviation correction control, and the like, toner (fog toner) deposited on a non-image portion, paper dust deposited on the intermediary transfer belt 12 from the recording material, and the like. Herein, as the deposited matter removed and collected from on the intermediary transfer belt 12 by the belt cleaning device 19, description will be made by principally paying attention to the transfer residual toner.

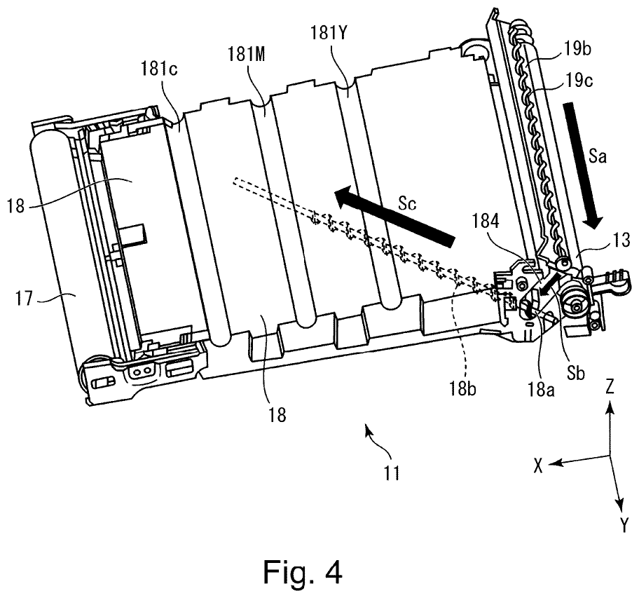

FIG. 4 is a schematic perspective view showing a structure of the belt unit 11 in a state in which the intermediary transfer belt 12 is removed (demounted) from the belt unit 11. Arrows Sa, Sb, and Sc in FIG. 4 show a conveying path of collected toner collected from on the intermediary transfer belt 12 by the cleaning blade 19b. Incidentally, in order to illustrate an inside structure of the belt cleaning device 19, in FIG. 4, the cleaning container 19a is omitted from illustration.

The belt cleaning device 19 includes, inside the cleaning container 19a, the cleaning blade 19b and a conveying member 19c, in the cleaning container 19a, for conveying the transfer residual toner scraped off from on the intermediary transfer belt 12 by the cleaning blade 19b. The conveying member 19c in the cleaning container 19a has a screw shape and conveys the collected toner in an arrow Sa direction (Y direction in this embodiment) by being rotated by receiving a driving force from a driving source of a driving device (not shown) provided in the apparatus main assembly 2.

The collected toner conveyed in the arrow Sa direction inside the cleaning container 19a is conveyed in an arrow Sb direction in a conveying path 184 provided adjacent to a downstream-side end portion with respect to a collected toner conveying direction by the conveying member 19c in the cleaning container 19a. Incidentally, the downstream-side end portion with respect to the collected toner conveying direction by the conveying member 19c in the cleaning container 19a is, in other words, a driving-side end portion of the belt unit 11. The conveying path 184 is connected to an inflow port 18a of the collected toner container 18. Further, inside the collected toner container 18, a conveying member 18b provided in the neighborhood of the inflow port 18a on one end side thereof. The conveying member 18b has a screw shape and conveys the collected toner, reached the inflow port 18a, in an arrow Sc direction.

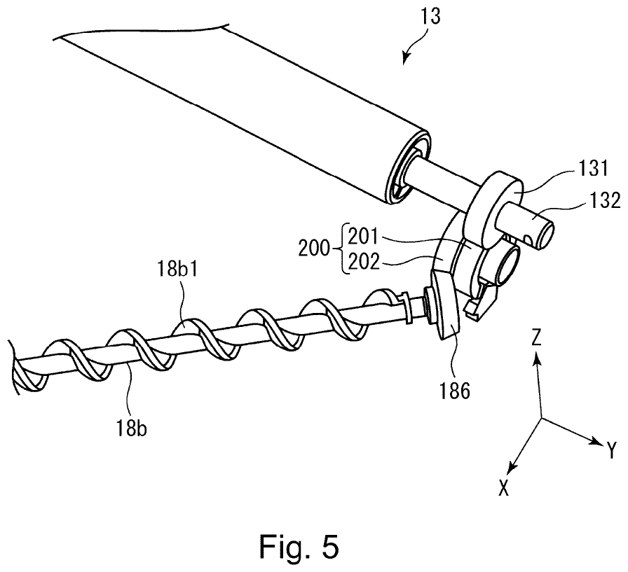

FIG. 5 is a schematic perspective view for illustrating a mechanism provided in a driving-side end portion of the belt unit 11 and for transmitting drive to the driving roller 13 and the conveying member 18b. As shown in FIG. 5, in this embodiment, the conveying member 18b and the driving roller 13 are drive-connected by a drive-connecting member 200 including a first drive-connecting gear portion 201 and a second drive-connecting gear portion 202. Specifically, the driving roller 13 includes a drive transmission gear 131 on a shaft portion 132 of the driving-side end portion, and the conveying member 18b includes an input gear 186 in a driving-side end portion thereof. Further, the drive transmission gear 131 engages with the first drive-connecting gear portion 201, and the input gear 186 engages with the second drive-connecting gear portion 202. The drive-connecting member 200 provided with the first drive-connecting gear portion 201 and the second drive-connecting gear portion 202 is integrally rotated. The driving roller 13 is rotated by receiving a driving force from a driving source through the shaft portion 132 of the driving-side end portion. When the shaft portion 132 is rotated, the drive transmission gear 131 is also rotated. When the drive transmission gear 131 is rotated, a rotational force of the driving roller 13 is transmitted to the input gear 186 through the drive-connecting member 200, so that the conveying member 18b is rotated.

### 4. Structure of Belt Unit

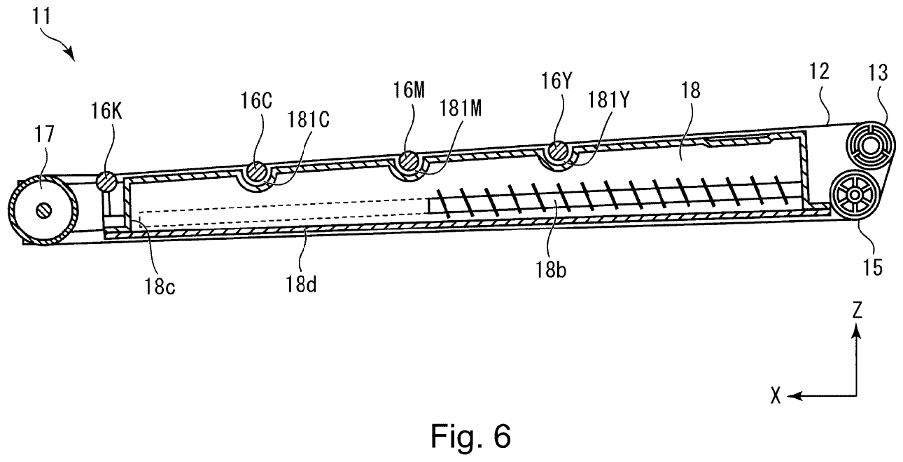

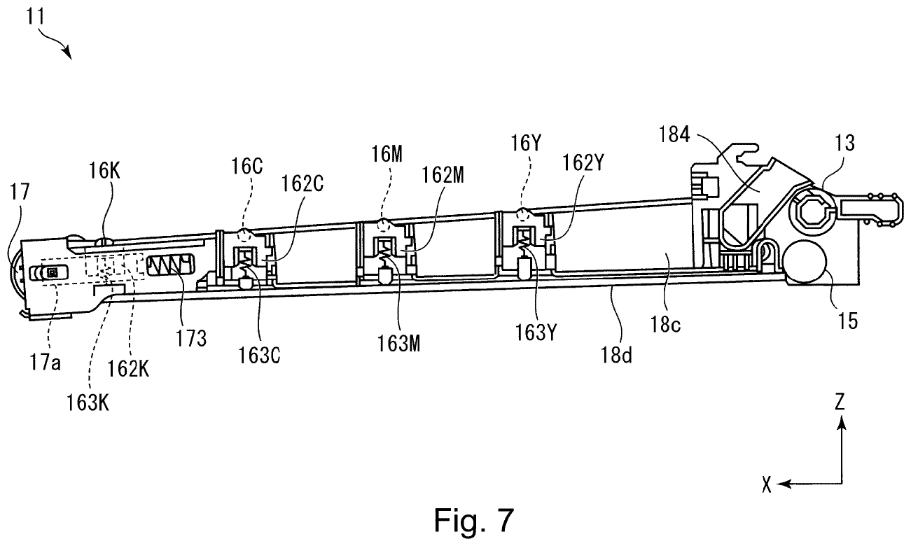

Next, a structure of the belt unit 11 in this embodiment will be further described. FIG. 6 is a schematic sectional view (XZ plane) of the belt unit 11 as viewed from a driving side. Further, FIG. 7 is a schematic sectional view (XZ plane) for illustrating the structure of the belt unit 11 in a side portion on the driving side. Here, in FIG. 7, the intermediary transfer belt 12 is omitted from illustration.

As shown in FIG. 6 and FIG. 7, in this embodiment, the collected toner container 18 is provided in a region of the belt unit 11 constituted by an inner peripheral surface of the intermediary transfer belt 12. Further, bottoms of the belt unit 11 and the collected toner container 18 are disposed so as to be substantially parallel to the bottom of the image forming apparatus 1.

In this embodiment, with respect to a direction of gravitation, the collected toner container 18 includes an upper-side member 18c constituting an upper surface thereof and a lower-side member 18d constituting the bottom thereof. By the upper-side member side 18c and the lower-side member 18d, a frame of the collected toner container 18 is constituted. Specifically, with respect to the direction of gravitation, the upper-side member 18c is disposed on a side closer to the primary transfer rollers 16, and the lower-side member 18d is disposed on a side closer to a bottom of the image forming apparatus 1. Further, the upper-side member 18c and the lower-side member 18d are disposed so that four sides of end portions of one of the upper-side member 18c and the lower-side member 18d which have a substantially rectangular shape on an XY plane are bonded to four sides of end portions of the other member, respectively, by ultrasonic welding. By this, the upper-side member 18c and the lower-side member 18d are integrally connected with each other, and constitute the frame of the collected toner container 18. Incidentally, a fixing means of the upper-side member 18c and the lower-side member 18d is not limited to the ultrasonic welding, but the fixing means may only be required to be a method capable of sufficiently suppressing leakage of the collected toner from the collected toner container 18. As the fixing means of the upper-side member 18c and the lower-side member 18d, for example, it is possible to use an arbitrary fixing means including, in addition to the ultrasonic welding, another welding such as thermal welding; fastening; bonding; and the like.

As shown in FIG. 6, portions of the upper-side members 18c opposing the primary transfer rollers 16Y, 16M, and 16C for yellow, magenta, and cyan are retracted in a direction apart from positions, where the primary transfer rollers 16Y, 16M, and 16C are provided. That is, these portions are retracted in a direction toward the lower-side member 18d. Specifically, in the positions, of the upper-side member 18c, where the primary transfer rollers 16Y, 16M, and 16Cc are provided, groove portions 181Y, 181M, and 181C are formed along rotational axis directions of the primary transfer rollers 16Y, 16M, and 16C.

By this, the collected toner container 18 is capable of sufficiently ensuring a toner accommodating capacity without restricting rotation of the primary transfer rollers 16Y, 16M, and 16C. Further, by forming the groove portions 181Y, 181M, and 181C on the upper-side member 18c, the collected toner container 18 can be improved in strength, so that deformation of the collected toner container 18 can be suppressed.

As shown in FIG. 7, the primary transfer rollers 16Y, 16M, 16C, and 16K are rotatably supported by primary transfer bearings 162Y, 162M, 162C, and 162K in end portions thereof with respect to their rotational axis directions. The primary transfer bearings 162Y, 162M, 162C, and 162K are urged in +Z direction by primary transfer (bearing) urging springs 163Y, 163M, 163C, and 163K, respectively, where re urging members as urging means fixed to the upper-side member 18c in one end side thereof. Further, the primary transfer bearings 162Y, 162M, 162C, and 162K are supported by the upper-side member 18c in a movable state along the Z direction.

In this embodiment, the belt unit 11 does not include a mechanism for separating the primary transfer rollers 16Y, 16M, 16C, and 16K from the intermediary transfer belt 12. That is, in a state in which the belt unit 11 is mounted in a predetermined position of the apparatus main assembly 2, each primary transfer roller 16 is urged by the primary transfer urging spring 163, so that the intermediary transfer belt 12 and the associated photosensitive drum 41 are always put in a contact state. Thus, the mechanism for separating each primary transfer roller 16 from the intermediary transfer belt 12 is not provided in the belt unit 11, so that an inside region of the belt unit 11 is capable of being utilized as a capacity (volume) of the collected toner container 18 to the maximum.

Further, the tension roller 17 is urged in +X direction by a tension spring 173 which is an urging member as an urging means through a tension bearing 17a. By this, the tension roller 17 imparts a predetermined tension to the intermediary transfer belt 12.

Here, the tension spring 173 urges the tension bearing 17a on one end side thereof and is supported by the upper-side member 18c on the other end side. Further, in this embodiment, the belt unit 11 is constituted so that a stretching state of the intermediary transfer belt 12 by the tension roller 17 can be eliminated by moving the tension bearing 17a against an urging force of the tension spring 173.

### 5. Filling of Collected Toner Into Collected Toner Container

Next, filling of the collected toner into the collected toner container 18 in this embodiment will be described.

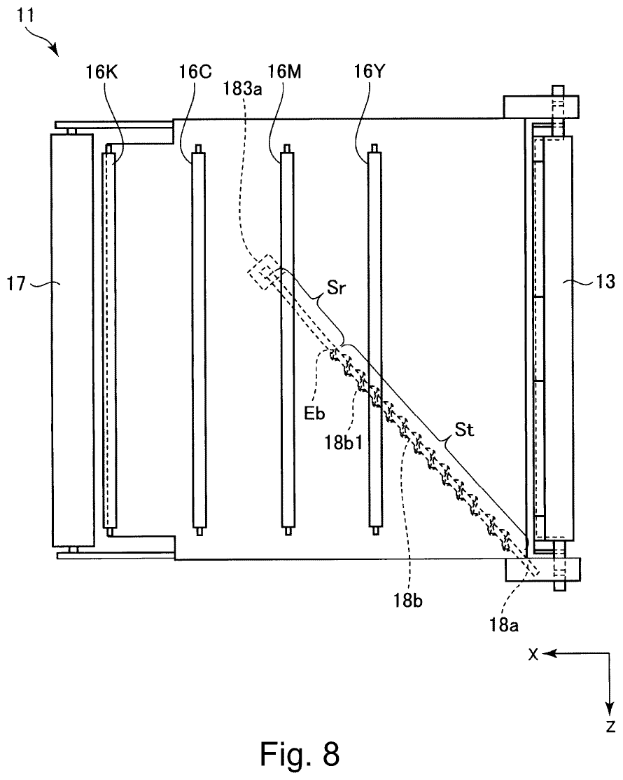

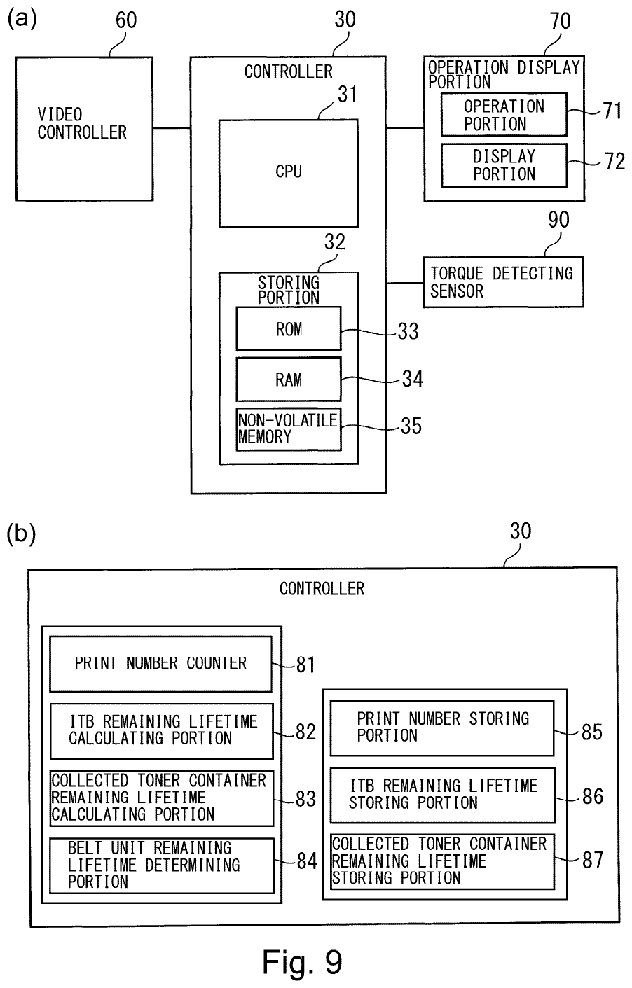

FIG. 8 is a schematic view (XY plane) of the belt unit 11 in a state in which the intermediary transfer belt 12 is removed (de-mounted) from the intermediary transfer belt 12 as viewed from above.

The collected toner flowing into the collected toner container 18 through the inflow port 18a via conveying path 184 (FIG. 4, FIG. 7) which is not shown in FIG. 8 is conveyed toward a substantially central portion of the collected toner container 18 in the XY plane.

With respect to the rotational axis direction of the conveying member 18b, the conveying member 18b is provided on an inflow port 18a side in one end portion thereof, and is supported by a conveying member 183a as a supporting portion in the other portion thereof. The conveying member bearing 183a is provided to the lower-side member 18d in the collected toner container 18, and rotatably supports the conveying member 18b. The conveying member 18b includes, with respect to a rotational axis direction thereof, a first region St provided with a conveying portion (screw blade) 18b1 and a second region Sr constituted only by a shaft portion without being provided with the conveying portion 18b1. At a boundary between the first region St and the second region Sr, with respect to the rotational axis direction of the conveying member 18b, an end portion (terminal portion) Eb of the conveying portion 18b1 on a side opposite from the inflow port 18a. Here, the rotational axis direction of the conveying member 18b is disposed along a direction which is not perpendicular to the X direction and the Y direction but which crosses the X direction and the Y direction. Incidentally, the X direction is substantially parallel to the movement direction of the intermediary transfer belt 12 in the XY plane, and the Y direction is substantially parallel to the rotational axis direction of the primary transfer roller 16 in the XY plane.

in the case where the collected toner container 18 is viewed by being projected on the XY plane, the end portion Eb is provided, with respect to the X direction, on a side downstream of the primary transfer roller 16Y for yellow and upstream of the primary transfer roller 16K for black. In other words, the end portion Eb is provided between the primary transfer roller 16Y for yellow and the primary transfer roller 16K for black with respect to the X direction. Specifically, in this embodiment, the end portion Eb is provided in a central region of the collected toner container 18 between the primary transfer roller 16Y for yellow and the primary transfer roller 16M for magenta with respect to the X direction. By this, the collected toner flowing from the inflow port 18a into the collected toner container 18 is conveyed from the inflow port 18a toward the end portion Eb inside the collected toner container 18 by the conveying portion 18b1, and is deposited in a substantially central portion, of the collected toner container 18, which is a terminal portion of the region St.

When the collected toner container 18 approaches a full state, a toner density in the neighborhood of the end portion Eb increases. By this, a torque of the conveying member 18b increases. Therefore, in this embodiment, the conveying member 18b is provided with a torque detecting sensor 90 (part (a) of FIG. 9) for detecting the torque of the conveying member 18b. Further, in the case where the torque of the conveying blade 19b detected by the torque detecting sensor 90 exceeded a predetermined threshold, the controller 30 (part (a) of FIG. 9) is configured to be capable of discriminating that the collected toner container 18 was close to a full state. Further, in the case where a pixel count value from a point of time when the torque of the conveying blade 19b detected by the torque detecting sensor 90 exceeded the predetermined threshold exceeded a predetermined threshold, the controller 30 is configured to be capable of discriminating that the collected toner container 18 was close to the full state. Details of a detecting method of a remaining lifetime of the collected toner container 18 will be described later.

### 6. Control Constitution

Next, a control constitution of the image forming apparatus 1 in this embodiment will be described. Part (a) of FIG. 9 is a block diagram showing a schematic control constitution of the image forming apparatus 1 of this embodiment.

The apparatus main assembly 2 is provided with the controller 30 as a control means. The controller 30 is constituted by including a CPU 31 as a control calculation means which is a central element, a storing portion 32 as a storing means, and an input/output portion (not shown) as an input/output means for transmitting and receiving signals between the controller 30 and an external device. The storing portion 32 is constituted by a ROM (Read Only Memory) 33, a RAM (Random Access Memory) 34, a non-volatile memory 35, and the like. In the ROM 33, various pieces of control information such as a program and a data table acquired in advance are stored. In the RAM 34, information inputted to the controller 30, detected information, a calculation result, and the like are stored. In the non-volatile memory 35, various pieces of setting information, various pieces of use history information (cumulative count values or the like by various counters), and the like are stored.

To the controller 30, an operation display portion 70 provided to the apparatus main assembly 2, and the torque detecting sensor 90 provided to the belt unit 11 are connected. The operation display portion 70 includes an operating portion 71 as an input means for inputting information to the controller 30 on the basis of an operator such as a user or a service person (hereinafter, simply also referred to as a “user”), and a display portion 72 as a display portion 72 as a display means for displaying information to the user by control of the controller 30. Incidentally, in this embodiment, the operation display portion 70 is constituted by including a touch panel having functions of the operating portion 71 and the display portion 72. The torque detecting sensor 90 inputs, to the controller 30, a signal indicating a detection result of the torque of the conveying member provided to the collected toner container 18 as described above. Further, although omitted from illustration, to the controller 30, the respective portion of the image forming apparatus 1 for executing the above-described image forming process are connected. In addition, to the controller 30, a video controller (image processing portion) 60 provided in the apparatus main assembly 2 is connected. The video controller 60 forms image data for forming an image in the image forming apparatus 1, on the basis of image information inputted from an external device (not shown) such as an image reading apparatus, a digital camera, or a personal computer, which is connected to the image forming apparatus 1.

The controller 30 integrally controlling the respective portions of the image forming apparatus 1 on the basis of image data formed by the video controller 60 depending on an image forming signal (image information, control insurrection) from the external device, and thus causes the image forming apparatus 1 to execute the image forming operation. For example, the controller 30 executes control relating to conveyance of the recording material, control relating to drive of the intermediary transfer belt 12 and the image forming portions P, control relating to the image formation, and further control relating to remaining lifetime detection of various consumable parts and relating to various failure detection, and the like control. Incidentally, a job (print job) is a series of operations which is started by a single start instruction and in which the image is formed on a single recording material S or a plurality of recording materials S.

### 7. Detection of Remaining Lifetime

Next, detection of a remaining lifetime of the intermediary transfer belt 12, detection of a remaining lifetime of the collected toner container 18, and determination of the remaining lifetime of the belt unit 11 in this embodiment will be described.

### <Constitution>

Part (b) of FIG. 9 is a schematic view showing a functional block of the controller 30 relating to the detection of the remaining lifetime of the intermediary transfer belt 12, the detection of the remaining lifetime of the collected toner container 18, and the determination of the remaining lifetime of the belt unit 11. The controller 30 is provided with a print number counter 81, an ITB remaining lifetime calculating portion 82, a collected toner container remaining lifetime calculating portion 83, and a belt unit remaining lifetime determining portion 84.

In this embodiment, these portions are realized by execution of programs stored in the ROM 33 of the storing portion 32 by the CPU 31. However, all or at least a part of functions of these portions may be realized by a hardware circuit such as an ASIC (application-specific integrated circuit) or an FPGA (field-programmable gate array). Further, the controller 30 is provided with a print number storing portion 85, an ITB remaining lifetime storing portion 86, and a collected toner container remaining lifetime storing portion 87. In this embodiment, each of these storing portions is constituted by a corresponding storage area of the non-volatile memory 35 in the storing portion 32 of the controller 30. However, at least one of the storing portions may be constituted by an individual storing portion (storing medium). Incidentally, in this embodiment, the ITB remaining lifetime calculating portion 82 constitutes a first acquiring portion for acquiring a value relating to the remaining lifetime of the intermediary transfer belt 12. Further, in this embodiment, the collected toner container remaining lifetime calculating portion 83 constitutes a second acquiring portion for acquiring a value relating to the remaining lifetime of the collected toner container 18. Further, in this embodiment, the belt unit remaining lifetime determining portion 84 constitutes a processing portion for executing processing notifying information on the remaining lifetime of the belt unit 11.

### <Detection of Remaining Lifetime of Intermediary Transfer Belt>

First, the detection of the remaining lifetime of the intermediary transfer belt 12 will be described.

The ITB remaining lifetime calculating portion 82 calculates the remaining lifetime of the intermediary transfer belt 12. The remaining lifetime of the intermediary transfer belt 12 is determined by electrical deterioration due to energization with the image formation and deterioration due to abrasion by rotation. In this embodiment, the ITB remaining lifetime calculating portion 82 calculates the remaining lifetime of the intermediary transfer belt 12 on assumption that the remaining lifetime of the intermediary transfer belt 12 is determined by a print number of sheets (number of printed sheets). Incidentally, the remaining lifetime of the intermediary transfer belt 12 may be calculated in consideration of not only the print number of sheets but also a rotation time of the intermediary transfer belt 12, and the like. The remaining lifetime of the intermediary transfer belt 12 can be calculated by using an arbitrary index value when the arbitrary index value is an index value which enables estimation of the remaining lifetime of the intermediary transfer belt 12 and which correlates with a user amount of the intermediary transfer belt 12.

The print number counter 81 counts a cumulative value Np of the print number of sheets (the number of sheets of recording materials S on which images are formed) from an initial stage of use (at the time of new article) of the intermediary transfer belt 12, and the counted cumulative value Np is successively updated and stored in the print number storing portion 85.

Incidentally, the print number counter 81 may be configured to count the print number of sheets converted into the print number of sheets of recording materials S each having a predetermined size. The ITB remaining lifetime calculating portion 82 calculates a remaining lifetime (%) of the intermediary transfer belt 12 by the following formula: (Remaining lifetime of intermediary transfer belt) (%)=(1−Np/Lp)×100, in which Lp represents an ITB lifetime count which is the print number of sheets corresponding to the lifetime of the intermediary transfer belt 12 determined in advance, and is 150,000 sheets corresponding to 100% of the remaining lifetime of the intermediary transfer belt 12. The ITB remaining lifetime calculating portion 82 causes the ITB remaining lifetime storing portion 86 to store the calculated remaining lifetime of the intermediary transfer belt 12.

### <Detection of Remaining Lifetime of Collected Toner Container>

Next, detection of the remaining lifetime of the collected toner container 18 will be described.

The collected toner, such as the transfer residual toner (secondary transfer residual toner, toner of a test toner image (calibration toner), or fog toner, generated due to some factors. In the image forming apparatus 1 of this embodiment, most of the collected toner is the transfer residual toner. For that reason, in this embodiment, the collected toner container remaining lifetime calculating portion 83 calculates the remaining lifetime of the collected toner container 18 by calculating and estimating an amount of the transfer residual toner.

First, the collected toner container remaining lifetime calculating portion 83 calculates an amount of the toner used by the image formation from a pixel count value of an image separated for each color. The pixel count value refers to an integrated value of an image signal value of 255 gradation levels for one pixel (one picture element). In this embodiment, the video controller 60 integrates the pixel count value for the image on one surface (side) of the recording material S every time when the image is formed on one surface (side) of the recording material S. The collected toner container remaining lifetime calculating portion 83 acquires the video count value from the video controller 60. For example, an image forming region of an A4-size recording material S is 200×287 mm when a margin is 5 mm for each of four sides. In addition, for example, a resolution is 600 dpi, on a whole surface of the image forming region, there are 32,029,264 pixels. For that reason, there are 255 gradation levels for one pixel, so that in the case where a solid image of 255 in gradation level is formed on the whole surface, a value of 8,167,462,335 is the pixel count value of the ZA-size solid image. By multiplying the pixel count value by a transfer efficiency (95% in this embodiment), it is possible to acquire a pixel count value Nt corresponding to an amount of the counted toner collected in the collected toner container 18.

Further, from values of a weight of the toner, a capacity of the toner, and the like, a relationship between the pixel count value and a volume of the toner is known in advance. A volume of the collected toner container 18 is determined, so that a pixel count value at which the collected toner container 18 becomes full can be acquired in advance by calculation. When a container lifetime count LT which is a pixel count value corresponding to the lifetime (full state) of the collected toner container 18 acquired in advance is taken as 100%, the collected toner container remaining lifetime calculating portion 83 calculates a remaining lifetime (%) of the collected toner container 18 by subtracting the pixel count value Nt corresponding to the amount of the collected toner for the image on one surface (side) of the recording material from LT every time when the image formation is carried out. In the image forming apparatus 1 of this embodiment, for example, in the case where an image ratio of the solid image is 100%, when images each having an image ratio of 20% are formed on 150,000 sheets of recording materials S, the collected toner container 18 became full. The collected toner container remaining lifetime calculating portion 83 causes the collected toner container remaining lifetime storing portion 87 to store the calculated remaining lifetime of the collected toner container 18.

Here, for example, the transfer efficiency changes depending on a change an installation environment of the image forming apparatus 1, a change in triboelectric charge amount (electrified charge amount), a difference in kind of the recording material S (paper), or the like. For that reason, a predicted result of an amount of the collected toner by the pixel count value and an amount of the collected toner actually accumulated in the collected toner container 18 are deviated from each other in some instances. Therefore, in this embodiment, as described above, the torque detecting sensor 90 for detecting the torque of the conveying member 18b of the collected toner container 18 is provided. Further, in the case where detection that the collected toner container 18 was close to full is made by the torque detecting sensor 90, the collected toner container remaining lifetime calculating portion 83 corrects the remaining lifetime of the collected toner container 18 so that the remaining lifetime becomes a value corresponding to a state acquired in advance. That is, the collected toner container remaining lifetime calculating portion 83 updates the remaining lifetime of the collected toner container 18 stored in the collected toner container remaining lifetime storing portion 87 to the remaining lifetime of the collected toner container 18 corresponding to the state acquired in advance, and then causes the collected toner container remaining lifetime storing portion 87 to store the updated remaining lifetime. By this, the remaining lifetime of the collected toner container 18 can be detected with accuracy.

Incidentally, a method of calculating the remaining lifetime of the collected toner container 18 is not limited to a method using the pixel count or a method by measuring the torque of the conveying member. The remaining lifetime of the collected toner container 18 can be calculated using an arbitrary index value when the arbitrary index value is an index value which enables estimation of the remaining lifetime of the collected toner container 18 and which correlates with the amount of the collected toner collected in the collected toner container 18. For example, as a toner amount detecting means, an optical detecting means, a detecting means by weight measurement, a detecting means by measurement of electrostatic capacity, and the like are known. The toner amount detecting means also includes a detecting means using the pixel count and a detecting means by measurement of the torque of the conveying member, and the above-described detecting means can be used in arbitrary combinations.

### <Determination of Remaining Lifetime of Belt Unit>

Next, an outline of determination of the remaining lifetime of the belt unit 11 will be described.

As described above, in a constitution in which the collected toner container 18 is provided inside the belt unit 11, even when an outer appearance of the belt unit 11 is viewed, the collected toner container 18 cannot be recognized.

For that reason, even when the remaining lifetime of the collected toner container 18 is displayed on an information confirmation screen, there is a possibility that the user cannot know that the remaining lifetime of what part is displayed, and thus is confused.

Therefore, in this embodiment, the belt unit remaining lifetime determining portion 84 determines the remaining lifetime of the belt unit 11 on the basis of the remaining lifetime of the intermediary transfer belt 12 and the remaining lifetime of the collected toner container 18. Further, in this embodiment, the remaining lifetime of the belt unit 11 determined by the belt unit remaining lifetime determining portion 84 is displayed on the operation display portion 70. Thus, in this embodiment, in the image forming apparatus 1, the remaining lifetime of the intermediary transfer belt 12 and the remaining lifetime of the collected toner container 18 are not separately displayed on the operation display portion 70, but a constitution in which a single remaining lifetime as the remaining lifetime of the belt unit 11 is displayed on the operation display portion 70 is employed. Particularly, in this embodiment, the image forming apparatus 1 has a constitution in which a shorter remaining lifetime (a lower remaining lifetime value) of the remaining lifetime of the intermediary transfer belt 12 and the remaining lifetime of the collected toner container 18 is displayed as the remaining lifetime of the collected toner container 18 on the operation display portion 70.

### 8. Determination and Display of Remaining Lifetime of Belt Unit

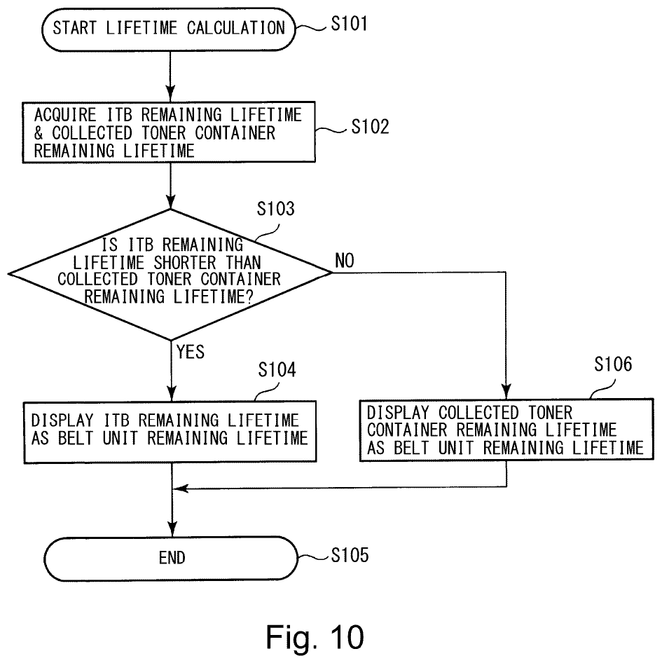

Next, control of determination and display of the remaining lifetime of the belt unit 11 in this embodiment will be described. FIG. 10 is a flowchart showing an example of procedure of this control.

In the case where a power source of the image forming apparatus 1 is turned on (during actuation) or in the case where the image forming apparatus 1 is restored from a sleep state (during restoration from the sleep state), the controller 30 starts calculation (computation) of the remaining lifetime of the belt unit 11 (S101). The controller 30 acquires the remaining lifetime of the intermediary transfer belt 12 and the remaining lifetime of the collected toner container 18 from the storing portion (intermediary transfer belt remaining lifetime storing portion 86, collected toner container remaining lifetime storing portion 87) (S102). Next, the controller 30 (belt unit remaining lifetime determining portion 84) checks that which one of the remaining lifetime of the intermediary transfer belt 12 and the remaining lifetime of the collected toner container 18 is shorter (S103). Specifically, in this embodiment, the controller 30 (belt unit remaining lifetime determining portion 84) discriminates whether or not the remaining lifetime of the intermediary transfer belt 12 is shorter than the remaining lifetime of the collected toner container 18. Then, in the case where the controller 30 (belt unit remaining lifetime determining portion 84) discriminated in S103 that the remaining lifetime of the intermediary transfer belt 12 is shorter than the remaining lifetime of the collected toner container 18 (“YES”), the controller 30 carries out control so that the remaining lifetime of the intermediary transfer belt 12 is displayed as the remaining lifetime of the belt unit 11 on the operation display portion 70 (S104). On the other hand, in the case where the controller 30 (belt unit remaining lifetime determining portion 84) discriminated in S103 that the remaining lifetime of the collected toner container 18 is shorter than the remaining lifetime of the intermediary transfer belt 12 (“NO”), the controller 30 carries out control so that the remaining lifetime of the collected toner container 18 is displayed as the remaining lifetime of the belt unit 11 on the operation display portion 70 (S106). Then, after the controller 30 executes processing for displaying the remaining lifetime of the belt unit 11 in S104 or S106, the controller 30 ends processing of the determination and the display of the remaining lifetime of the belt unit 11 (S105). Incidentally, the determined remaining lifetime of the belt unit 11 is stored in the RAM 34 of the storing portion 32 and is successively updated every time when the remaining lifetime of the belt unit 11 is determined. Further, in the case where the remaining lifetime of the collected toner container 18 and the remaining lifetime of the intermediary transfer belt 12 are the same, the controller 30 (belt unit remaining lifetime determining portion 84) is capable of determining and displaying the same remaining lifetime as the remaining lifetime of the belt unit 11.

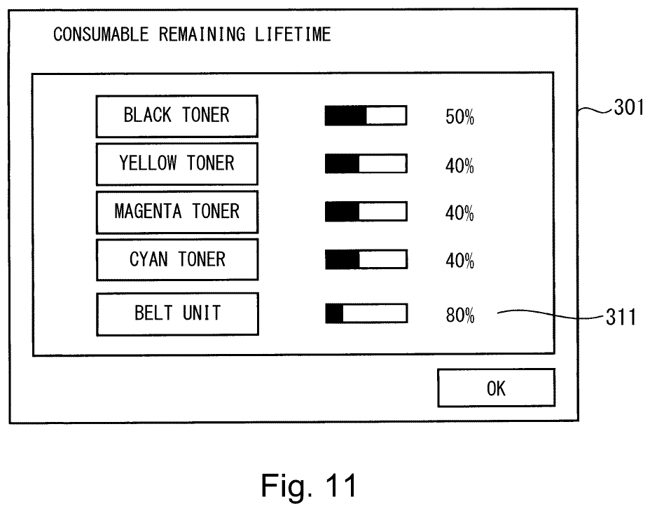

FIG. 11 is a schematic view of an example of an information display portion 301 displayed on the operation display portion 70. As shown in FIG. 11, the information display portion 301 is provided with a belt unit remaining lifetime display portion 311 for displaying the remaining lifetime of the belt unit 11, so that the remaining lifetime of the belt unit 11 determined in processing in the controller 30 as described above. Incidentally, the information display portion 301 as shown in FIG. 11 may be configured to be displayed in the case of being called up by a predetermined operation by the user in the operation display portion 70 and may also be displayed as a part of a main screen or the like irrespective of a special calling operation.

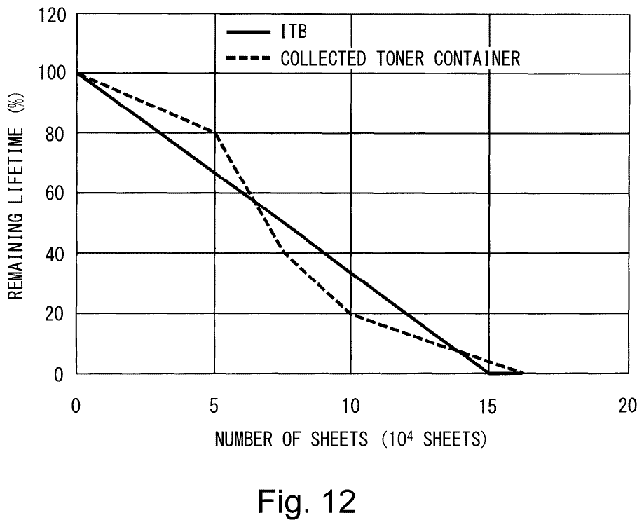

FIG. 12 is a graph showing an example of progressions of the remaining lifetime of the intermediary transfer belt 12 and the remaining lifetime of the collected toner container 18. In FIG. 12, an abscissa represents a print number of sheets (10⁴ sheets) and an ordinate represents a remaining lifetime (%). A solid line in FIG. 12 shows the progression of the remaining lifetime of the intermediary transfer belt 12, and when the print number reaches 150,000 sheets, the remaining lifetime of the intermediary transfer belt 12 becomes 0%.

A broken line in FIG. 12 shows the progression of the remaining lifetime of the collected toner container 18. For example, when an image having an image ratio exceeding 20% is formed, an inclination of the progression of the remaining lifetime of the collected toner container 18 becomes larger in a negative direction than an inclination of the progression of the remaining lifetime of the intermediary transfer belt 2. A shorter one of the remaining lifetime of the intermediary transfer belt 12 and the remaining lifetime of the collected toner container 18, which is determined and displayed as the remaining lifetime of the belt unit 11 is the remaining lifetime positioned in a lower position in the graph of FIG. 12.

In the example shown in FIG. 12, in a period from 65(×10³ sheets) to 137.5(×10³ sheets), as the remaining lifetime of the belt unit 11, the remaining lifetime of the collected toner container 18 is displayed, and in other periods, as the remaining lifetime of the belt unit 11, the remaining lifetime of the intermediary transfer belt 12 is displayed.

Thus, in this embodiment, the image forming apparatus 1 includes the image forming portion P for forming the toner image on the image bearing member (photosensitive drum 41; the belt unit 11 detachably mountable to the apparatus main assembly 2 of the image forming apparatus 1 and including the endless belt (intermediary transfer belt) 12 onto which the toner image is transferred from the image bearing member 41 and the collected toner container 18 which is provided in a region constituted by an inner peripheral surface of the belt 12 and which is for accommodating toner collected in the apparatus main assembly 2; the first acquiring portion (ITB remaining lifetime calculating portion) 82 for acquiring a value relating to the remaining lifetime of the belt 12; the second acquiring portion (collected toner container remaining lifetime calculating portion) 83 for acquiring a value relating to the remaining lifetime of the collected toner container 18; and the processing portion (belt unit remaining lifetime determining portion) 84 for executing processing for notifying information on a remaining lifetime of the belt unit 11 on the basis of a first acquisition result by the first acquiring portion 82 and a second acquisition result by the second acquiring portion 83. Further, in this embodiment, the processing portion 84 executes the processing so as to notify the information on the remaining lifetime of the belt unit 11 on the basis of a lower one of a value of the remaining lifetime (remaining lifetime of the intermediary transfer belt 12) indicated by the first acquisition result and a value of the remaining lifetime (remaining lifetime of the collected toner container 18) indicated by the second acquisition result. Further, in this embodiment, the image forming apparatus 1 includes the display portion (operation display portion) 70 for displaying information, wherein the processing portion 84 executes the processing so as to display the information on the remaining lifetime of the belt unit 11 in the operation display portion 70. Incidentally, the processing portion 84 may execute the processing so as to display the information on the remaining lifetime of the belt unit 11 in the device (personal computer or the like) communicatably connected to the image forming apparatus 1. Further, in this embodiment, the image forming apparatus 1 includes the cleaning device (belt cleaning device) 19 for removing the toner from the belt 12, wherein the collected toner container 18 acquires the toner removed from the belt 12 by the cleaning device 19.

As described above, according to this embodiment, the remaining lifetime of the collected toner container 18 which is not seen from an outer appearance of the belt unit 11 is not displayed, and the remaining lifetime of the belt unit 11 which can be clearly and visually recognized as a consumable (part) is displayed. By this, it is possible to reduce a possibility that the user is confused due to that the user cannot recognize that the remaining lifetime of what part is displayed, which can occur in the case where the remaining lifetime of the collected toner container 18 which is not seen from the outer appearance is displayed. Accordingly, in a constitution in which the collected toner container 18 is provided inside the belt unit 11, a user convenience relating to exchange of the belt unit 11 can be improved.

### Embodiment 2

Next, another embodiment (embodiment 2) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 1 will be omitted from detailed description by adding thereto the same reference numerals or symbols as those in the embodiment 1.

In this embodiment, an operation (processing) of the image forming apparatus 1 when the belt unit 11 reaches an end of the lifetime thereof will be described. In this embodiment, the operation of the image forming apparatus 1 when the belt unit 11 reaches the end of the lifetime thereof is different between the case where a factor of lifetime arrival of the belt unit 1 is lifetime arrival of the intermediary transfer belt 12 and the case where the factor is lifetime arrival of the collected toner container 18.

Here, the lifetime arrival of the intermediary transfer belt 12 means the case where the intermediary transfer belt 12 was used to a state in which a printing performance using the intermediary transfer belt 12 cannot be ensured.

In this embodiment, as described in the embodiment 1, the lifetime of the intermediary transfer belt 12 is set to the print number of 150,000 sheets. Further, in the case where this print number (150,000 sheets) is taken as 100%, when the remaining lifetime (%) of the intermediary transfer belt 12 calculated on the basis of the cumulative value of the print number of sheets, it is regarded as that the intermediary transfer belt 12 reaches the end of the lifetime thereof (lifetime arrival).

Further, the lifetime arrival of the collected toner container 18 means the case where the collected toner container 18 became a state in which the collected toner container 18 is discriminated as becoming a full state. In this embodiment, as described in the embodiment 1, the case where the calculated remaining lifetime of the collected toner container 18 become 0% is regarded as the lifetime arrival of the collected toner container 18.

Further, the lifetime arrival of the belt unit 11 means the case where at least one of the intermediary transfer belt 12 and the collected toner container 18 reached the end of the lifetime thereof.

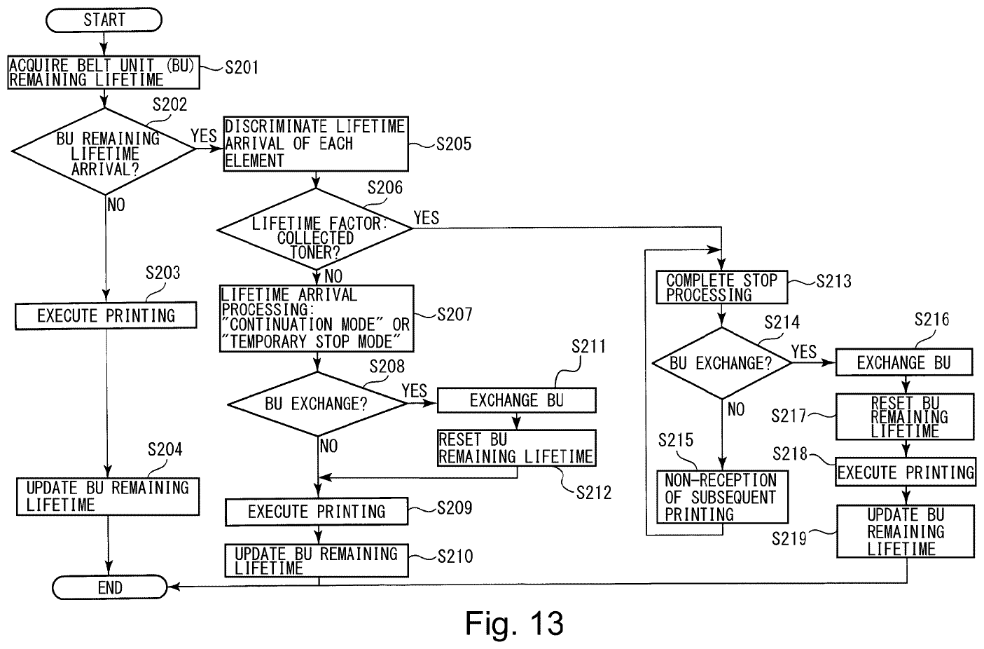

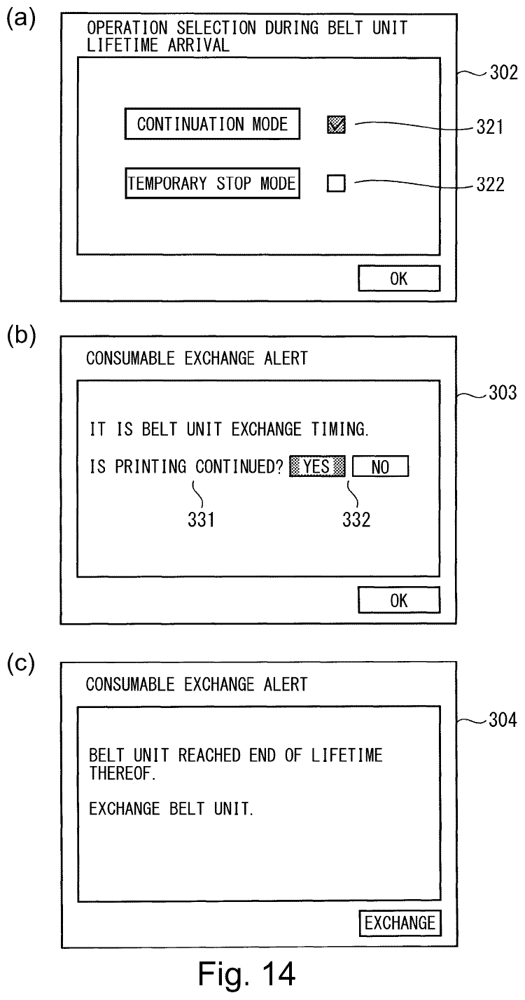

Next, control of the operation of the image forming apparatus 1 when the belt unit 11 reached the end of the lifetime thereof will be described. FIG. 13 is a flowchart showing an example of procedure of this control. In this embodiment, the case where a start instruction of a print job is inputted to the image forming apparatus 1 by actuating the image forming apparatus 1, or the like will be described.

The controller 30 acquires the remaining lifetime of the belt unit 11 in a manner as described in the embodiment 1 during the actuation of the image forming apparatus 1 or during the restoration of the image forming apparatus 1 from the sleep state (S201). That is, the controller 30 acquires the remaining lifetime of the belt unit 11 detected in the belt unit remaining lifetime determining portion 84 on the basis of the remaining lifetime of the intermediary transfer belt 12 and the remaining lifetime of the collected toner container 18. Next, the controller 30 discriminates whether or not the belt unit 11 reached the end of the lifetime thereof (S202).

In the case where the controller 30 discriminated in S202 that the belt unit 11 does not reach the end of the lifetime thereof (“NO”), the controller 30 executes the print job (S203). Then, the controller 30 updates the remaining lifetime of the belt unit 11 (S204), and ends the processing. Incidentally, updating processing of the remaining lifetime of the belt unit 11 may be performed every execution of the printing for one page or every completion of a single print job.

Further, in the case where the controller 30 discriminated in S202 that the belt unit 11 reached the end of the lifetime thereof (“YES”), the controller 30 acquires the remaining lifetime of the intermediary transfer belt 12 and the remaining lifetime of the collected toner container 18 and then performs processing for checking that which one of the intermediary transfer belt 12 and the collected toner container 18 reached the end of the lifetime thereof (S205). Then, the controller 30 discriminates whether or not a factor of the lifetime arrival of the belt unit 11 is the lifetime arrival of the collected toner container 18 (S206). In the case where the controller 30 discriminated in S206 that the factor of the lifetime arrival is not the lifetime arrival of the collected toner container 18 (“NO”), i.e., that the factor of the lifetime arrival is the lifetime arrival of the intermediary transfer belt 12, the controller 30 executes “lifetime arrival processing” (S207).

In the “lifetime arrival processing” of S207, specifically, the following processing is performed. That is, in this embodiment, although the image forming apparatus 1 cannot provide image guarantee in the case where the factor of the lifetime arrival of the belt unit 11 is the lifetime arrival of the intermediary transfer belt 12, the belt unit 11 can be continuously used by discrimination of the user. Further, in this embodiment, the image forming apparatus 1 is configured so that the user is capable of presetting, from a setting screen, a display timing of an alert enabling determination by the user as to whether or not the image forming apparatus 1 continuously uses the belt unit 11, and a number of times of subsequent display. In this embodiment, the user is capable of selecting either one of a “continuation mode” or a “temporary stop mode” as described below.

Part (a) of FIG. 14 is a schematic view of an example of a setting screen 302 of the lifetime arrival processing displayed on the operation display portion 70. As shown in part (a) of FIG. 14, on the setting screen 302, a first selecting portion 321 for selecting the “continuation mode” and a second selecting portion 322 for selecting the “temporary stop mode” and provided, so that the user is capable of selecting either one of these modes. Incidentally, the setting screen 302 as shown in part (a) of FIG. 14 is displayed in the case where the setting screen 302 is called up by a predetermined operation performed by the user in the operation display portion 70. Further, in a default, for example, the “temporary stop mode” is selected.

Further, part (b) of FIG. 14 is a schematic view of an example of an alert screen 303 displayed in the operation display portion 70 in S207. As shown in part (b) of FIG. 14, in addition to a message 331 prompting discrimination whether or not the belt unit 11 is continuously used such that for example, “IS PRINTING CONTINUED?”, determining buttons 332 such as “YES” and “NO” are provided. The “continuation mode” is a mode in which when the “YES” of the determining button 332 is selected on the alert screen 303 as shown in part (b) of FIG. 14, the belt unit 11 can be used continuously, and in addition, thereafter the alert is not displayed. In this case, during subsequent actuation or the like, the alert screen 303 is not displayed in S207, and processing of S209 and later described hereinafter is performed. The “temporary stop mode” is a mode in which by selecting the “YES” of the determining button 332 on the alert screen 303 as shown in part (b) of FIG. 14, the belt unit 11 can be continuously used, and in addition, thereafter the alert is displayed. In this case, thereafter, every during actuation or the like, the alert screen 303 is displayed, and similarly as described above, by selecting the “YES” of the determining button 332, the belt unit 11 can be continuously used.

In the case where the “YES” button 332 is selected on the alert screen 303 as shown in part (b) of FIG. 14, the controller 30 confirms that the belt unit 11 is not exchanged (S208) and then executes the print job (S209). Then, the controller 30 updates the remaining lifetime of the belt unit 11 (S210), and ends the processing. Further, the user is also capable of exchanging the belt unit 11 depending on a use status or the like. In the case where the “NO” of the determining button 332 is selected on the alert screen 303 as shown in part (b) of FIG. 14, the controller 30 confirms that the belt unit 11 was exchanged (S211), and then resets (initializes) the remaining lifetime of the belt unit 11 to an initial value (100% in this embodiment) (S212). Incidentally, at this time, the controller 30 also resets (initializes) each of the remaining lifetime of the intermediary transfer belt 12 and the remaining lifetime of the collected toner container 18 to an initial value (100% in this embodiment). Incidentally, the controller 30 is capable of confirming the exchange of the belt unit 11 depending on a predetermined operation (selection of an exchange confirmation button of the belt unit 11 or the like) in the operation display portion 70 by the user. Or, the controller 30 may be configured to be capable of confirming the exchange of the belt unit 11 by detecting that the belt unit 11 is a new article on the basis of a memory tag (presence/absence of predetermined information or the like) provided to the belt unit 11.

Further, in the case where the “NO” of the determining button 332 is selected on the alert screen 303 as shown in part (b) of FIG. 14, the controller 30 may cause the operation display portion 70 to display information prompting the exchange of the belt unit 11 (this information may also be information explaining an exchange method). Thereafter, the controller 30 executes the print job (S209). Then, the controller 30 updates the remaining lifetime of the belt unit 11 (S210), and ends the processing.

On the other hand, in the case where the controller 30 discriminated in S206 that the collected toner container 18 reached the end of the lifetime thereof (“YES”), the controller executes “COMPLETE STOP PROCESSING” (S213). In the case where the controller 30 discriminated that the collected toner container 18 reached the end of the lifetime thereof, when the image forming operation is continued, there is a liability of occurrences of inconveniences such as breakage of a driving portion (gear or the like) due to an increase in torque of the conveying member provided to the collected toner container 18, and scattering of the counted toner. For that reason, in this case, as the “COMPLETE STOP PROCESSING”, the controller 30 carries out control so as not to receive a subsequent print job until the belt unit 11 is exchanged. That is, the controller 30 discriminates whether or not the belt unit 11 is exchanged (S214), and in the case where the controller 30 discriminated that the belt unit 11 is not exchanged (“NO”), the controller 30 carries out control so as not to receive the print job (so as not to execute the print job) (S215). Incidentally, in S213, the controller 30 is capable of causing the operation display portion 70 to display an alert screen 304 showing information prompting the exchange of the belt unit 11 (this information may also be information explaining the exchanging method). Further, in the case where the controller 30 discriminated in S214 that the belt unit 11 is exchanged (“YES”), the controller 30 confirms that the belt unit 11 was exchanged (S216), and resets (initializes) the remaining lifetime of the belt unit 11 to an initial value (100% in this embodiment) (S217). Incidentally, at this time, the controller 30 resets (initializes) each of the remaining lifetime of the intermediary transfer belt 12 and the remaining lifetime of the collected toner container 18 to an initial value (100% in this embodiment). Thereafter, the controller 30 executes the print job (S218). Then, the controller 30 updates the remaining lifetime of the belt unit 11 (S219) and ends the processing.

Incidentally, in the case where the controller 30 selected in S207 that the belt unit 11 is continuously used, thereafter, the remaining lifetime of the belt unit 11 may be displayed as a negative value by being decreased to a negative side with respect to 0% or may also be kept at 0%. Thereafter, in the case where the collected toner container 18 reached the end of the lifetime thereof, processing of S213 and later is performed, so that continuous use of the belt unit 11 cannot be made, and thus the operation of the image forming apparatus 1 is stopped.

Here, in the case where the remaining lifetime of the belt unit 11 was close to 0% (in the case where the remaining lifetime of the belt unit 11 reached a predetermined value higher than 0% or in the like case), the controller 30 may perform control so that information notifying the user of that effect is displayed in the operation display portion 70. Further, in that case, the display may be changed depending on that the remaining lifetime of the belt unit 11 is determined by which one of the remaining lifetime of the intermediary transfer belt 12 and the remaining lifetime of the collected toner container 18. For example, in the case where the remaining lifetime of the belt unit 11 at that time is determined by the remaining lifetime of the intermediary transfer belt 12 (in the case where the remaining lifetime of the intermediary transfer belt 12 is shorter than the remaining lifetime of the collected toner container 18), it is possible to display a message such that “Belt unit is close to end of lifetime thereof.”. On the other hand, in the case where the remaining lifetime of the belt unit 11 at that time is determined by the remaining lifetime of the collected toner container 18 (in the case where the remaining lifetime of the collected toner container 18 is shorter than the remaining lifetime of the intermediary transfer belt 12), it is possible to display a message such that “Belt unit comes near end of lifetime thereof.”. By this, for example, contents of the above-described display are confirmed by another information such as a service manual of the image forming apparatus 1, whereby a service person or the like becomes easy to specify a factor of lifetime arrival of the belt unit 11.

Thus, in this embodiment, the image forming apparatus 1 includes the controller 30 for executing pieces of control different between the case where the remaining lifetime value indicated by the first acquisition result by the first acquiring portion (ITB remaining lifetime calculating portion) 82 reaches the first value corresponding to a lifetime of the belt 12 set in advance and the case where the remaining lifetime value indicated by the second acquisition result by the second acquiring portion (collected toner container remaining lifetime calculating portion) 83 reaches the second value corresponding to the lifetime of the collected toner container 18 set in advance. Further, the controller 30 executes control so that formation of the toner image by the image forming portion P is permitted without a condition that the belt unit 11 is exchanged in the case where the remaining lifetime value indicated by the first acquisition result reaches the first value and so that the formation of the toner image by the image forming portion P is permitted on condition that the belt unit 11 is exchanged in the case where the remaining lifetime value indicated by the second acquisition result reaches the second value.

As described above, according to this embodiment, an effect similar to the effect of the embodiment 1 can be obtained, and in addition, depending on the factor such that the belt unit 11 reached the end of the lifetime thereof, whether or not the belt unit 11 is made continuously usable. By this, the continuous use of the belt unit 11 is enabled in an allowable range of the user, and in addition, in the case where the collected toner container 18 becomes full, an occurrence of an inconvenience such as scattering of the counted toner can be prevented.

### Embodiment 3

Next, another embodiment (embodiment 3) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 1 will be omitted from detailed description by adding thereto the same reference numerals or symbols as those in the embodiment 1.

As described in the embodiment 2, in the case where the factor of the lifetime arrival of the belt unit 11 is the lifetime arrival of the intermediary transfer belt 12, the belt unit 11 can be continuously used in the allowable range of the user. For that reason, it is also possible to assume that the user desires that the remaining lifetime of the collected toner container 18 is always displayed as the remaining lifetime of the belt unit 11.

Therefore, the image forming apparatus 1 can also be constituted so that the user is capable of selecting either one of a “first display mode” in which a shorter one of the remaining lifetime of the intermediary transfer belt 12 and the remaining lifetime of the collected toner container 18 as described in the embodiment 1 as the remaining lifetime of the belt unit 11 and a “second display mode” in which the remaining lifetime of the collected toner container 18 is always displayed as the remaining lifetime of the belt unit 11.

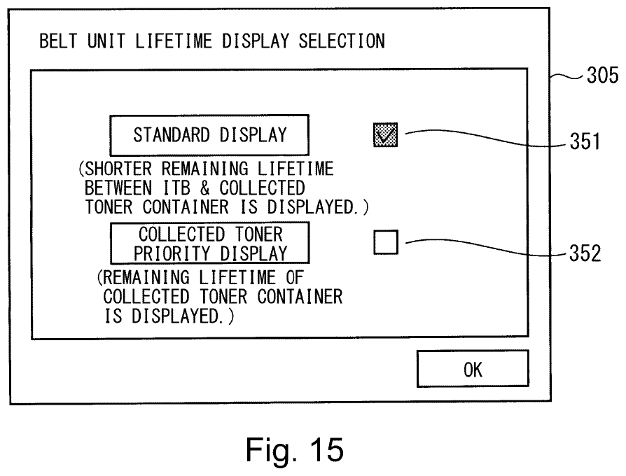

FIG. 15 is a schematic view of an example of a setting screen 305 of the remaining lifetime display displayed on the operation display portion 70. As shown in FIG. 15, on the setting screen 305, a first selecting portion 351 for selecting the above-described “first display mode” and a second selecting portion 352 for selecting the above-described “second display mode” and provided, so that the user is capable of selecting either one of these modes. Incidentally, the setting screen 305 as shown in FIG. 15 is displayed in the case where the setting screen 305 is called up by a predetermined operation performed by the user in the operation display portion 70. Further, in a default, for example, the above-described “first display mode” is selected.

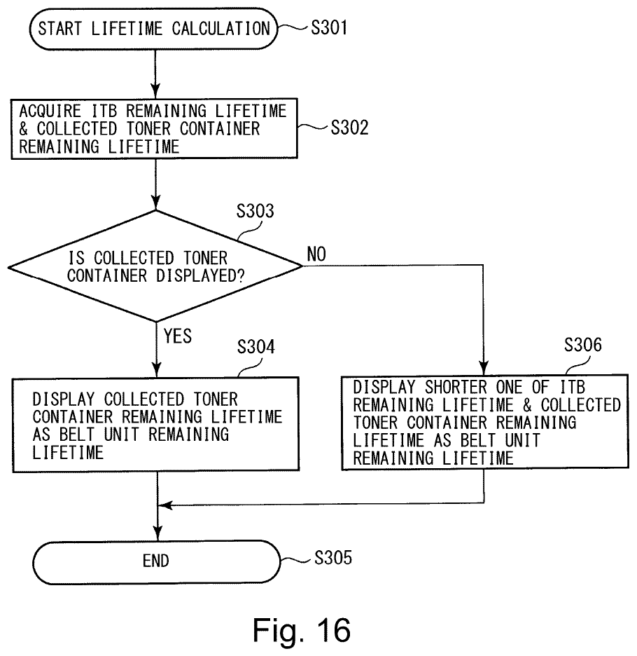

FIG. 16 is a flowchart showing an example of a procedure of control of determination and display of the remaining lifetime of the belt unit 11 in the case where a display mode of the remaining lifetime of the belt unit 11 is made selectable.

The controller 30 starts calculation (computation) of the remaining lifetime of the belt unit 11 during actuation of the image forming apparatus 1 or during restoration of the image forming apparatus 1 from a sleep state (S301). The controller 30 (belt unit remaining lifetime determining portion 84) acquires the remaining lifetime of the intermediary transfer belt 12 and the remaining lifetime of the collected toner container 18 from the storing portion 32 (ITB remaining lifetime storing portion 86, collected toner container remaining lifetime storing portion 87) (S302). Next, the controller 30 (belt unit remaining lifetime determining portion 84) checks a setting of the display mode of the remaining lifetime of the belt unit 11, and discriminates that which one of the first display mode and the second display mode is selected (S303). Specifically, in this embodiment, the controller 30 (belt unit remaining lifetime determining portion 84) discriminates whether or not the second display mode (in which the remaining lifetime of the collected toner container 18 is displayed as the remaining lifetime of the belt unit 11) is selected. Then, in the case where the controller 30 (belt unit remaining lifetime determining portion 84) discriminated in S303 that the second display mode is selected (“YES”), the controller 30 performs control so as to cause the operation display portion 70 to display the remaining lifetime of the collected toner container 18 as the remaining lifetime of the belt unit (S304). On the other hand, in the case where the controller 30 (belt unit remaining lifetime determining portion 84) discriminated in S303 that the second display mode is not selected (“NO”), i.e., in the case where the controller 30 discriminated that the first display mode is selected, similarly as described above in the embodiment 1, the controller 30 performs control so as to cause the operation display portion 70 to display, as the remaining lifetime of the belt unit 11, the shorter one of the remaining lifetime of the intermediary transfer belt 12 and the remaining lifetime of the collected toner container 18 (S306). Then, the controller 30 executes processing for displaying the remaining lifetime of the belt unit in S304 or S306, and thereafter, ends the processing of determination and display of the remaining lifetime of the belt unit 11 (S305).

Further, as in this embodiment, in the case where the display mode of the remaining lifetime of the belt unit 11 is selectable and where the above-described second display mode is selected, in an operation described in the embodiment 2 and when the belt unit 11 reached the end of the lifetime thereof, the following operation is performed. That is, in the case where the “continuation mode” is selected, when the factor of the lifetime arrival of the belt unit 11 is the lifetime arrival of the intermediary transfer belt 12, the belt unit 11 is continuously used without executing the processing corresponding to the lifetime arrival processing of S207 in FIG. 13. In addition, in this case, the remaining lifetime of the intermediary transfer belt 12 is gradually updated to a negative value by being decreased to a negative side with respect to 0%. On the other hand, in the case where the collected toner container 18 reached the end of the lifetime thereof, the continuous use of the belt unit 11 cannot be made, so that the operation of the image forming apparatus 1 is stopped.

Thus, in this embodiment, the image forming apparatus 1 includes the input portion (operation display portion) 70 for inputting an instruction to the processing portion (belt unit remaining lifetime determining portion) 84, and the processing portion 84 executes processing so as to notify information on the remaining lifetime of the belt unit 11 depending on the instruction inputted from the input portion 70, on the basis of a remaining lifetime value indicated by a second acquisition result of a second acquiring portion (collected toner container remaining lifetime calculating portion) 83, which is one of a remaining lifetime value indicated by a first acquisition result of a first acquiring portion (ITB remaining lifetime calculating portion) 82 and the remaining lifetime value indicated by the second acquisition result.

As described above, it is enabled that the remaining lifetime of the collected toner container 18 is always displayed as the remaining lifetime of the belt unit 11, so that depending on a request from the user, convenience of the user relating to the exchange of the belt unit 11 can be improved.

### Embodiment 4

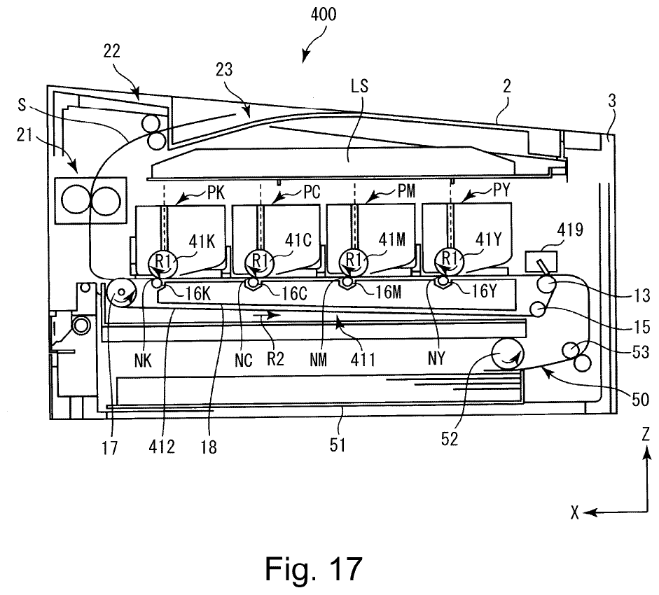

In the embodiments 1 to 3, the case where the present disclosure was applied to the image forming apparatus 1 of the intermediary transfer type in which the intermediary transfer belt 12 is provided was described. On the other hand, the present disclosure is also applicable to an image forming apparatus 400 of a direct transfer type in which a conveying belt 412 is provided as shown in FIG. 17. In the image forming apparatus 400 of FIG. 17, elements having identical or corresponding functions or constitutions as those in the image forming apparatus 1 of FIG. 2 will be omitted from detailed description by adding thereto the same reference numerals or symbols as those in the image forming apparatus 1 of FIG. 2. Incidentally, as regards the image forming apparatus 400 of FIG. 17, a right side in FIG. 19 where the openable door 3 is provided in a “front (front surface) side”, and a left side in FIG. 17 opposite from the front side is a “rear (rear surface) side”. As viewed from the front side, a left side is a “driving side”, and a right side is a “non-driving side”. Further, in the image forming apparatus 400 of FIG. 17, a direction from the front side toward the rear side is a “(+)X direction”.

In the image forming apparatus 400 shown in FIG. 17, the recording material S fed from the cassette 51 is carried and conveyed by the conveying belt 412 constituted by an endless belt as a recording material carrying member. On an inner peripheral surface side of the conveying belt 412, a transfer roller 16 which corresponds to the primary transfer roller 16 in the image forming apparatus 1 of FIG. 2 and which is a roller-type transfer member as a transfer means is provided. The transfer roller 16 forms a transfer portion (transfer nip) N where the photosensitive drum 41 and the conveying belt 412 are in contact with each other. Then, onto the recording material S carried and conveyed by the conveying belt 412, color toner images of yellow, magenta, cyan, and black are successively transferred superposedly. The recording material S on which the toner images are transferred is separated from the conveying belt 412, and thereafter, is subjected to fixing by the fixing device 21, and is discharged to the tray 23 on an outside of an apparatus main assembly of the image forming apparatus 400.

Also, in the image forming apparatus 400 of FIG. 17, toner of the test toner image, fog toner, and the like are deposited on the conveying belt 412, and therefore, a belt cleaning device 419 for cleaning these toners is provided. Further, in the image forming apparatus 400 of FIG. 17, similarly as in the image forming apparatus 1 of FIG. 2, a belt unit (conveying belt unit) 411 provided with the conveying belt 412 and stretching rollers therefor is provided with the collected toner container 18 in a region inside the conveying belt 412.

Further, in the image forming apparatus 400 of FIG. 17, the remaining lifetime of the belt unit 411 is determined on the basis of the remaining lifetime of the conveying belt 412 and the remaining lifetime of the collected toner container 18 similarly as in the above-described embodiments, and this remaining lifetime can be displayed. Further, as described in the embodiment 3, the user may be allowed to set the remaining lifetime of the collected toner container 18 as the remaining lifetime of the belt unit 411 so as to be displayed. By this, effects similar to those of the above-described embodiments can be obtained. As regards control of determination and display of the remaining lifetime of the belt unit 411, description in the above-described embodiments is invoked by replacing the intermediary transfer belt with the conveying belt. As described above, the present disclosure is also applicable to the

image forming apparatus 400 of the direct transfer type provided with the conveying belt 412, and effects identical or corresponding to those in the case where the present disclosure is applied to the image forming apparatus 1 of the intermediary transfer type can be obtained.

### Other Embodiments

In the above, the present disclosure was described based on the specific embodiments, but the present disclosure is not limited to the above-described embodiments.

In the above-described embodiments, the collected toner container was described as a collected toner container in which the toner collected from the belt is accommodated, but the collected toner container may also be constituted so as to accommodate the toner collected from the image bearing member such as the photosensitive drum instead of or in addition to the belt.

Further, in the above-described embodiments, the operations and the display which are described as being performed in the operation display portion provided in the image forming apparatus may also be performed in an operating portion or a display portion of an external device communicatably connected to the image forming apparatus. In this case, an input/output portion provided to the image forming apparatus functions as an input portion for inputting, to the controller, signals for various settings and as an output portion for outputting signals for performing various displays by the controller.

Further, notification of information is not limited to display characters or images, but for example, generation of voice by a voice generating means.

Further, in the above-described embodiments, as information on remaining lifetimes of the belt unit, the belt, and the collected toner container, description was made such that the remaining lifetime value (which is 0% in the case where the associated member reached the end of the lifetime thereof), but the information may only be required to be information capable of knowing that how long remaining lifetime remains. Accordingly, as the information on the remaining lifetime, a value of a use amount, which is 0% during an initial use (during new article) and 10% when the associated member reached the end of the lifetime thereof may also be used.

According to the present disclosure, in a constitution in which the collected toner container is provided inside the belt unit, it is possible to improve convenience of the user relating to the exchange of the belt unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-109926 filed on Jul. 8, 2024, which is hereby incorporated by reference herein in its entirety.

What is claimed is:

1. An image forming apparatus comprising:
an image forming portion configured to form a toner image on an image bearing member;
a belt unit detachably mountable to a main assembly of the image forming apparatus and including an endless belt onto which the toner image is transferred from the image bearing member and a collected toner container which is provided in a region constituted by an inner peripheral surface of the belt and which is configured to accommodate toner collected in the main assembly;
a first acquiring portion configured to acquire a value relating to a remaining lifetime of the belt;
a second acquiring portion configured to acquire a value relating to a remaining lifetime of the collected toner container; and
a processing portion configured to execute processing for notifying information on a remaining lifetime of the belt unit on the basis of a first acquisition result by the first acquiring portion and a second acquisition result by the second acquiring portion.

2. An image forming apparatus comprising:
an image forming portion configured to form a toner image on an image bearing member;
a belt unit detachably mountable to a main assembly of the image forming apparatus and including an endless belt for carrying and conveying a recording material onto which the toner image is transferred from the image bearing member and a collected toner container which is provided in a region constituted by an inner peripheral surface of the belt and which is configured to accommodate toner collected in the main assembly;
a first acquiring portion configured to acquire a value relating to a remaining lifetime of the belt;
a second acquiring portion configured to acquire a value relating to a remaining lifetime of the collected toner container; and
a processing portion configured to execute processing for notifying information on a remaining lifetime of the belt unit on the basis of a first acquisition result by the first acquiring portion and a second acquisition result by the second acquiring portion.

3. An image forming apparatus according to claim 1, wherein the processing portion executes the processing so as to notify the information on the remaining lifetime of the belt unit on the basis of a lower one of a remaining lifetime value indicated by the first acquisition result and a remaining lifetime value indicated by the second acquisition result.

4. An image forming apparatus according to claim 1, further comprising a display portion configured to display information,
wherein the processing portion executes the processing so as to display the information on the remaining lifetime of the belt unit in the display portion.

5. An image forming apparatus according to claim 1, wherein the processing portion executes the processing so as to display the information on the remaining lifetime of the belt unit in a device communicatably connected to the image forming apparatus.

6. An image forming apparatus according to claim 1, further comprising an input portion configured to input an instruction to the processing portion,
wherein in response to the instruction inputted from the input portion, the processing portion executes the processing so as to notify the information on the remaining lifetime of the belt unit on the basis of a remaining lifetime value indicated by the second acquisition result of the first and second acquisition results.

7. An image forming apparatus according to claim 1, further comprising a cleaning device configured to remove the toner from the belt,
wherein the collected toner container accommodates the toner removed from the belt by the cleaning device.

8. An image forming apparatus according to claim 1, further comprising a controller configured to execute pieces of control different between a case where a remaining lifetime value indicated by the first acquisition result reaches a first value corresponding to a lifetime of the belt set in advance and a case where a remaining lifetime value indicated by the second acquisition result reaches a second value corresponding to a lifetime of the collected toner container set in advance.

9. An image forming apparatus according to claim 8, wherein the controller executes control so that formation of the toner image by the image forming portion is permitted without a condition that the belt unit is exchanged in the case where the remaining lifetime value indicated by the first acquisition result reaches the first value and so that the formation of the toner image by the image forming portion is permitted on condition that the belt unit is exchanged in the case where the remaining lifetime value indicated by the second acquisition result reaches the second value.

10. An image forming apparatus according to claim 2, wherein the processing portion executes the processing so as to notify the information on the remaining lifetime of the belt unit on the basis of a lower one of a remaining lifetime value indicated by the first acquisition result and a remaining lifetime value indicated by the second acquisition result.

11. An image forming apparatus according to claim 2, further comprising a display portion configured to display information,
wherein the processing portion executes the processing so as to display the information on the remaining lifetime of the belt unit in the display portion.

12. An image forming apparatus according to claim 2, wherein the processing portion executes the processing so as to display the information on the remaining lifetime of the belt unit in a device communicatably connected to the image forming apparatus.

13. An image forming apparatus according to claim 2, further comprising an input portion configured to input an instruction to the processing portion,
wherein in response to the instruction inputted from the input portion, the processing portion executes the processing so as to notify the information on the remaining lifetime of the belt unit on the basis of a remaining lifetime value indicated by the second acquisition result of the first and second acquisition results.

14. An image forming apparatus according to claim 2, further comprising a cleaning device configured to remove the toner from the belt,
wherein the collected toner container accommodates the toner removed from the belt by the cleaning device.

15. An image forming apparatus according to claim 2, further comprising a controller configured to execute pieces of control different between a case where a remaining lifetime value indicated by the first acquisition result reaches a first value corresponding to a lifetime of the belt set in advance and a case where a remaining lifetime value indicated by the second acquisition result reaches a second value corresponding to a lifetime of the collected toner container set in advance.

16. An image forming apparatus according to claim 15, wherein the controller executes control so that formation of the toner image by the image forming portion is permitted without a condition that the belt unit is exchanged in the case where the remaining lifetime value indicated by the first acquisition result reaches the first value and so that the formation of the toner image by the image forming portion is permitted on condition that the belt unit is exchanged in the case where the remaining lifetime value indicated by the second acquisition result reaches the second value.
